(19) United States
(12) Patent Application Publication
(10) Pub. No.: US 2011/0232665 A1
(43) Pub. Date: Sep. 29, 2011

(54) PERSONAL SUPPORT

(76) Inventor: James R. Barnett, JR., Austin, TX (US)

(21) Appl. No.: 12/748,160

(22) Filed: Mar. 26, 2010

(51) Int. Cl. A47K 3/00; A61H 3/00; A45B 9/04

(52) U.S. Cl. 132/200; 135/67; 135/77; 135/66; 29/428; 4/571.1

(57) ABSTRACT

Provided in some embodiments is a portable personal support system and method of providing the same. In some embodiments, provided is a portable personal support including a frame having a support member of sufficient height to be grasped by a human while in a standing position. The frame including a three-sided barrier having at least one front barrier portion to be disposed in front of user during use and at least two side barrier portions to be disposed on either side of the user during use. At least one of the barrier portions includes a first panel portion and a second panel portion complementary to the first panel portion coupled to one another to form an integral barrier portion. At least a portion of the first panel portion includes a first edge portion, and at least a portion of the second panel includes a second edge portion complementary to the first edge portion that engage one another. At least a portion of the first panel and a complementary portion of the second panel define at least a portion of a hollow interior cavity of the integral barrier portion. In some embodiments, provided is a portable personal support system that includes a frame having a support member of sufficient height to be grasped by a human while in a standing position. The personal support system also includes at least three feet coupled to the frame, wherein at least one of the feet includes a suction cup to at least partially couple the frame to a supporting surface during use. The suction cup includes a flexible sealing cup configured to directly contact the supporting surface during use, and the sealing cup generates a suction to at least partially couple the frame to the supporting surface when the sealing cup is pressed against a supporting surface during use.

### BACKGROUND

1. Field of the Invention

The present invention generally relates to systems and methods for providing portable support for a person, and more particularly to a portable support for use by a person while walking, standing, sitting, bathing or participating in other activities.

2. Description of Related Art

Although various activities, such as walking, standing, sitting, or bathing are simple activities for many persons, other persons may find them physically difficult. More specifically, those with physical disabilities may be prone to slip and fall accidents that can result in serious injury. Persons with disabilities often rely on a portable support, such as a “walker”. Walkers typically include a rigid metal frame that a person can grasp for support and to help with balance. Unfortunately, traditional walkers have several drawbacks. For instance, traditional walkers often do not include an effective means for gripping a supporting surface during use. Further, a person may not be able to fix the position of the walker to the supporting surface to prevent the walker from moving. For instance, traditional walkers do not include an effective means for selectively securing the walker to a supporting surface during use. As a result, the walker may be unstable when used on a slippery supporting surface. Moreover, traditional metal framed walkers are formed of hard-metal frames that often include abrupt or sharp edges. During use, these edges can injure a user if, for example, the user slips and falls, hitting the frame and one of the sharp or abrupt edges. Further, traditional walkers do not include ergonomically friendly designs, and lack desirable aesthetics. As a result, many persons in need of a walker elect not to use one due to the discomfort and/or lack of aesthetic appeal. Further, traditional walkers are not particularly suited for use in a bathing environment. Traditional walkers, for example, are too wide to fit into a bathtub or shower, and do not include feet that are capable of securing against slippery surfaces typically associated with bath tubs and showers. As a result, persons are left with limited options for support in a bathing environment. With regard to providing support in a bathing environment, several solutions have been proposed, including fixed bathing supports. Fixed supports typically include a bar or rail that is rigidly fixed to a shower or bath wall. Unfortunately, such fixed support may require expensive and complex installation procedures, and may result in a permanent fixture that is not easily removed. This may be undesirable, for instance, when a disabled person can not afford the associated cost, or when a person experiencing a temporary disability does not want to install a permanent fixture. Further, fixed support may lack flexibility to be rearranged for use in different circumstances. For instance, a fixed support may provide support at an entrance to the shower, but may not provide support under the stream of water, or vice versa. The lack of flexibility may cause people to limit their actions while bathing. Thus, a person may not be able to wash their hair, turn around to rinse-off, and the like.

Accordingly, there is a desire for a system and method to provide a portable personal support that provides stability and that can be easily maneuvered in various environments. Further, there is a desire for the support to be ergonomic and aesthetically pleasing.

### SUMMARY

Various embodiments include a portable personal support system and method of providing the same. In one embodiment, provided is a portable personal support including a frame having a support member of sufficient height to be grasped by a human while in a standing position. The frame including a three-sided barrier having at least one front barrier portion to be disposed in front of user during use and at least two side barrier portions to be disposed on either side of the user during use. At least one of the barrier portions includes a first panel portion and a second panel portion complementary to the first panel portion coupled to one another to form an integral barrier portion. At least a portion of the first panel portion includes a first edge portion, and at least a portion of the second panel includes a second edge portion complementary to the first edge portion that engage one another. At least a portion of the first panel and a complementary portion of the second panel define at least a portion of a hollow interior cavity of the integral barrier portion.

In another embodiment, provided is a method for assembling a personal support that includes providing first panel portion of a barrier portion of the personal support. The first panel portion includes a first edge portion. The first panel portion is a portion of at least one barrier portion of the personal support. The personal support includes a frame having a support member of sufficient height to be grasped by a human while in a standing position. The frame includes a three-sided barrier having at least one front barrier portion to be disposed in front of user during use, and at least two side barrier portions to be disposed on either side of the user during use. The method includes providing a second panel portion of the barrier portion of the personal support that is complementary to the first panel portion, and includes a second edge portion complementary to the first edge portion. The method also includes coupling the first panel portion and the second panel portion to one another to form an integral barrier portion. Coupling the first panel portion and the second panel portion to one another includes engaging the first edge portion and the second edge portion to one another. At least a portion of the first panel and a complementary portion of the second panel define at least a portion of a hollow interior cavity of the integral barrier portion,

In another embodiment, provided is a portable support that includes a frame having a support member of sufficient height to be grasped by a human while in a standing position. The frame includes a three-sided barrier having at least one front barrier portion to be disposed in front of user during use, and at least two side barrier portions to be disposed on either side of the user during use. At least one of the barrier portions includes a first panel portion to be mated to a second panel portion complementary to the first panel portion to form an integral barrier portion. At least a portion of the first panel portion includes a recess/protrusion to engage a complementary protrusion/recess of the second panel portion when the first portion is mated to the second panel portion. At least a portion of the first panel includes a depression to define at least a portion of a hollow interior cavity of the integral barrier portion when the first portion is mated to the second panel portion. The hollow interior cavity includes a structural support member disposed therein.

In another embodiment, provided is a portable personal support that includes a frame having a support member of sufficient height to be grasped by a human while in a standing position, at least one foot coupled to the frame to contact a supporting surface during use. At least one foot includes a valve actuated suction cup. The suction cup includes a sealing cup configured to directly contact the supporting surface during use, wherein the sealing cup comprises a concave recess having an interior volume, and an orifice extending between the interior volume and an exterior volume. A valve is disposed in the orifice and is capable of being actuated between an open and a closed position to regulate the flow into and out of the interior volume via the orifice. Providing the valve in the closed position facilitates coupling of the suction cup to the supporting surface during use, and providing the valve in the opened position inhibits coupling of the suction cup to the supporting surface during use.

In another embodiment, provided is a portable bathing support for use in a standing position. The portable bathing support is capable of fitting within a shower and/or bathtub used for bathing, and the portable bathing support is configured for use by a human in a standing position without being fixedly coupled to the shower and/or bathtub. The support includes a frame having a support member of sufficient height to be grasped by a human while in a standing position and at least three feet coupled to the frame, wherein at least one of the feet comprises a valve actuated suction cup to selectively at least partially couple the portable bathing support to a shower and/or bathtub supporting surface during use. The valve actuated suction cup includes a sealing cup configured to directly contact the supporting surface during use, wherein the sealing cup comprises a concave recess having an interior volume, an orifice extending between the interior volume and an exterior volume, and a valve coupled to the orifice. The valve can be actuated between an open and a closed position to regulate the flow of air into and out of the interior volume via the orifice. Providing the valve in the closed position facilitates coupling of the valve actuated suction cup to the supporting surface during use, and providing the valve in the opened position inhibits coupling of the valve actuated suction cup to the supporting surface during use.

In yet another embodiment, provided is a walker support for use by a human. The walker support includes a frame having a support member of sufficient height to be grasped by a human while in a standing position, and at least three feet coupled to the frame. At least one of the feet comprises a valve actuated suction cup to selectively at least partially couple the walker support to a supporting surface during use. The valve actuated suction cup includes a sealing cup configured to directly contact the supporting surface during use, wherein the sealing cup comprises a concave recess having an interior volume, an orifice extending between the interior volume and an exterior volume, and a valve coupled to the orifice. The valve can be actuated between an open and a closed position to regulate the flow of air into and out of the interior volume via the orifice. Providing the valve in the closed position facilitates coupling of the valve actuated suction cup to the supporting surface during use, and providing the valve in the opened position inhibits coupling of the valve actuated suction cup to the supporting surface during use.

In another embodiment, provided is a portable personal support system that includes a frame having a support member of sufficient height to be grasped by a human while in a standing position. The personal support system also includes at least three feet coupled to the frame, wherein at least one of the feet includes a suction cup to at least partially couple the frame to a supporting surface during use. The suction cup includes a flexible sealing cup configured to directly contact the supporting surface during use, and the sealing cup generates a suction to at least partially couple the frame to the supporting surface (e.g., when the sealing cup is pressed against a supporting surface during use).

In another embodiment, provided is a portable bathing support for use in a standing position. The portable bathing support includes a frame having a support member of sufficient height to be grasped by a human while in a standing position and at least three feet coupled to the frame. The feet are able to provide a friction between the frame and a supporting surface. At least one foot includes a suction cup that can at least partially couple the portable bathing support to a shower and/or bathtub supporting surface during use. Further, wherein the portable bathing support can fit within a shower and/or bathtub used for bathing, and can be used by a human in a standing position without being fixedly coupled to the shower and/or bathtub.

In another embodiment, provided is a method of bathing while standing. The method includes disposing a portable bathing standing support at least partially into a shower and/or bathtub used for bathing. The portable bathing support includes a frame having a support member of sufficient height to be grasped by a human while in a standing position and a three-sided barrier. The three-sided barrier includes a front portion that can be disposed between a user and a water supply during use, and a rear portion opposite the front portion and having an opening accessible by a human to allow the human to walk to a position where three sides can be grasped by the human while in a standing position. The portable bathing support also includes at least three feet coupled to the frame. The feet can provide a friction between the frame and a supporting surface. At least one foot includes a suction cup that can at least partially couple the portable bathing support to a shower and/or bathtub supporting surface during use. The portable bathing support can fit within a shower and/or bathtub used for bathing, and can be used by a human in a standing position without being fixedly coupled to the shower and/or bathtub during use.

In yet another embodiment, provided is a portable bathing support. The portable bathing support includes a frame having at least two substantially vertical front support members, at least one substantially horizontal front support member of sufficient height to be grasped by a user while in a standing position. At least one substantially horizontal front support member extends between the two substantially vertical front support members. The frame also includes at least two substantially vertical rear support members and at least two side support members of sufficient height to be grasped by a user while in a standing position. Each of the at least two side support members extends between one of the two substantially vertical front support members and one of the two substantially vertical rear support members. The frame forms a three-sided barrier that includes a front portion that can be disposed between a user and a water supply during use, and a rear portion opposite the front portion and having an opening accessible by a human to allow the human to walk to a position where three sides can be grasped by the human while in a standing position. The at least two substantially vertical front support members and the at least two substantially vertical rear support members are adjustable in length such that a height of the bathing support is adjustable. The at least one substantially horizontal front support member is adjustable in length such that a width of the bathing support is adjustable. Further, one or more feet coupled to a lower portion of the frame, wherein the one or more feet can at least partially couple the portable bathing support to a porcelain shower and/or bathtub supporting surface during use.

In another embodiment, provided is a portable support for use in a standing position. The portable support includes a frame having a support member of sufficient height to be grasped by a human while in a standing position and at least one securing foot coupled to the frame. One or more of the at least one securing foot are able to provide a friction between the frame and a supporting surface. One or more of the at least one securing foot includes a suction cup that can at least partially couple the portable support to a surface during use. The bathing support also includes at least one roller foot coupled to the frame. One or more of the at least one roller foot facilitates movement between the portable support and the supporting surface during use.

In another embodiment, provided is a method of bathing while standing. The method includes disposing a portable bathing standing support at least partially into a shower and/or bathtub used for bathing. The portable bathing support includes a frame having a support member of sufficient height to be grasped by a human while in a standing position and a three-sided barrier. The three-sided barrier includes a front portion that can be disposed between a user and a water supply during use, and a rear portion opposite the front portion and having an opening accessible by a human to allow the human to walk to a position where three sides can be grasped by the human while in a standing position. The portable bathing support also includes at least one securing foot coupled to the frame. One or more of the at least one securing foot can provide a friction between the frame and a supporting surface. One ore more of the at least one securing foot includes a suction cup that can at least partially couple the portable bathing support to a shower and/or bathtub supporting surface during use. The portable bathing support also includes at least one roller foot coupled to the frame. One or more of the at least one roller foot facilitates movement between the portable bathing support and the supporting surface during use. The portable bathing support can fit within a shower and/or bathtub used for bathing, and can be used by a human in a standing position without being fixedly coupled to the shower and/or bathtub during use.

In yet another embodiment, provided is a portable support. The portable support includes a frame having at least two substantially vertical front support members, at least one substantially horizontal front support member of sufficient height to be grasped by a user while in a standing position. At least one substantially horizontal front support member extends between the two substantially vertical front support members. The frame also includes at least two substantially vertical rear support members and at least two side support members of sufficient height to be grasped by a user while in a standing position. Each of the at least two side support members extends between one of the two substantially vertical front support members and one of the two substantially vertical rear support members. The frame forms a three-sided barrier includes a front, and a rear portion opposite the front portion and having an opening accessible by a human to allow the human to walk to a position where three sides can be grasped by the human while in a standing position. The at least two substantially vertical front support members and the at least two substantially vertical rear support members are adjustable in length such that a height of the support is adjustable. The at least one substantially horizontal front support member is adjustable in length such that a width of the bathing support is adjustable. Further, the bathing support includes at least two feet coupled to a lower portion of the frame, wherein one or more of the at least two feet can at least partially couple the portable support to a supporting surface, and one or more of the at least two feet are configured to facilitate movement of the portable support during use.

### BRIEF DESCRIPTION OF THE DRAWINGS

Advantages of the present invention will become apparent to those skilled in the art with the benefit of the following detailed description and upon reference to the accompanying drawings in which:

FIG. 1A illustrates a perspective view of a support in accordance with one or more embodiments of the present technique.

FIG. 1B illustrates a top view of the support of FIG. 1A in accordance with one or more embodiments of the present technique.

FIG. 1C illustrates a perspective view of the support of FIG. 1A in a folded configuration in accordance with one or more embodiments of the present technique.

FIG. 2 illustrates a perspective view of a support in a bathing environment in accordance with one or more embodiments of the present technique.

FIG. 3A illustrates a water supply support in accordance with one or more embodiments of the present technique.

FIG. 3B illustrates an integral water supply in accordance with one or more embodiments of the present technique.

FIGS. 4A-4G illustrate alternate embodiments of feet portions of the support in accordance with one or more embodiments of the present technique.

FIG. 5A-5D illustrate a cross-sectioned side view of a valve actuated suction cup in accordance with one or more embodiments of the present technique.

FIG. 6A illustrates an exploded view of panels of a side barrier portion of the support in accordance with one or more embodiments of the present technique.

FIG. 6B illustrates a side view of an interior of a panel of a side barrier portion of the support in accordance with one or more embodiments of the present technique.

FIG. 6C illustrates a cross-sectioned view of an interface of assembled panels of a side barrier portion of the support in accordance with one or more embodiments of the present technique.

FIG. 6D illustrates a cross-sectioned view of a lower portion of the panel of FIG. 6B including a foot in accordance with one or more embodiments of the present technique.

FIG. 6E illustrates a side view of a lower portion of the panel of FIG. 6B including a foot in accordance with one or more embodiments of the present technique.

FIG. 7 illustrates positioning of the support during use in accordance with one or more embodiments of the present technique.

FIG. 8 illustrates an alternate embodiment of the support in accordance with one or more embodiments of the present technique.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF ILLUSTRATIVE EMBODIMENTS

As discussed in more detail below, certain embodiments of the present technique provide for a portable support. More particularly, certain embodiments provide a portable support for use while walking, standing, sitting, bathing or participating in other activities. The techniques described herein may be of particular benefit for use of support on slippery surfaces, such as porcelain, tile, concrete or other generally impervious surfaces that can become very slippery when wet. In some embodiments, the support is portable, and can be folded when not in use (e.g., during transport). In certain embodiments, the support can be used in a substantially fixed position in a shower or bathtub (e.g., when entering or leaving the shower or bathtub), and/or as support while moving over a supporting surface (e.g., a slick floor) or similar walking environment. The support, in certain embodiments includes a rail (e.g., a handle or grab bar) that can be grasped by a person in a standing position. The support, in some embodiments, includes an adjustable height and/or width. The support in some embodiments can be adjusted such that its width is approximately the same as a width of the inside of the shower/bathtub that it is intended to be used in. The support in some embodiments includes feet or similar devices, such as pads or suction cups that prevent undesirable movement or slipping of the support. In some embodiments, the feet or similar deices may be selectively actuated such that they can be provided in a state that facilitates fixing the position of the support and/or a state that facilitates movement of the support. In certain embodiments, at least one of the feet includes a suction cup having a valve that can be selectively provided in a closed position to seal an interior volume of the suction cup, thereby facilitating fixing the support to a supporting surface, and that can be selectively provided in an open position to open the interior volume of the suction cup, thereby facilitating uncoupling of the suction cup from the supporting surface such that the support being easily moved relative to the supporting surface. The support, in certain embodiments includes rollers or similar devices that may facilitate movement and positioning of the support. The support, in some embodiments, includes convenience features, such as padded grips, a supply container, a shower head support or system, a foot rest, a seat and the like. The support in some embodiments, includes a substantially composite frame. In certain embodiments, portions of the frame include an injection molded plastic/polymer, such as acrylonitrile butadiene styrene (ABS). In some embodiments, the composite frame includes ergonomic and aesthetically pleasing features, such as contoured handles and curved side walls forming an enclosure (e.g., a three sided barrier) that at least partially wraps around the user during use. In some embodiments, the support includes one or more barrier portions (e.g., front and side barrier portions). In certain embodiments, each of the barrier portions include two or more panel portions that are formed separately, and subsequently coupled to one another to from the respective barrier portion. In certain embodiments, the two or more panel portions include “halves” that are bonded to one another to from an integral barrier portions (e.g., a front, left or right side of the support frame). In some embodiments, the two or more portions define a hollow-internal cavity or channel the enables cables/wires/cords strings (e.g., a wire used to actuate the valve of a valve actuated suction cup) to be routed internal to the support frame. In certain embodiments, the interior cavities include support structures, such as ribs or fins that provide increased rigidity and strength to the fame. Some of the embodiments described herein are believed to provide a desirable personal support such as a walker support and/or a bathing support that can be easily maneuvered in a bathing environment to provide a safe, secure and convenient bathing experience.

Although some embodiments are described herein with respect to a support adapted for use as walker and/or a support adapted for use in a bathing environment, the techniques described herein are also applicable to supports used in both of these environments, as well as supports used in a variety of other environments. A “walker” refers to a support that is used by a person to maintain balance while walking, standing, or participating in other activities. A “bathing support” may refer to a support that is adapted for use in a bathing environment, such as a shower and/or bathtub used by persons for bathing. Accordingly, features described with respect to a support may be applicable to walkers, bathing supports, and/or similar supports.

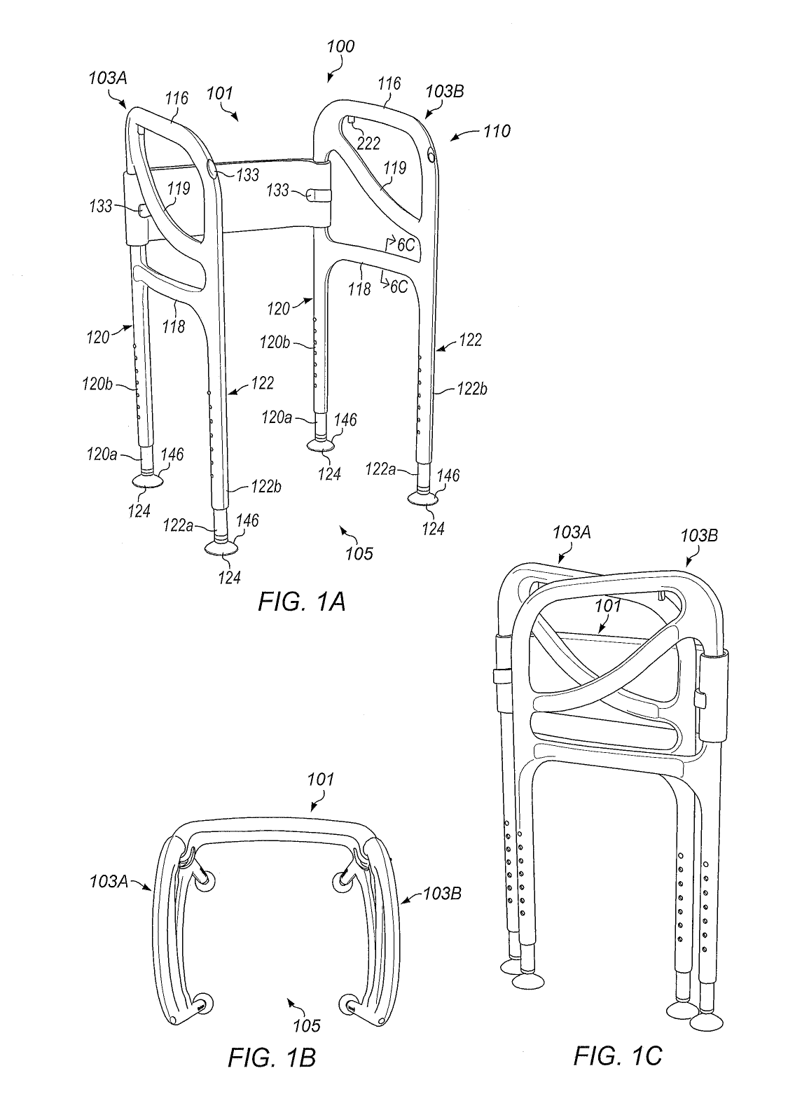

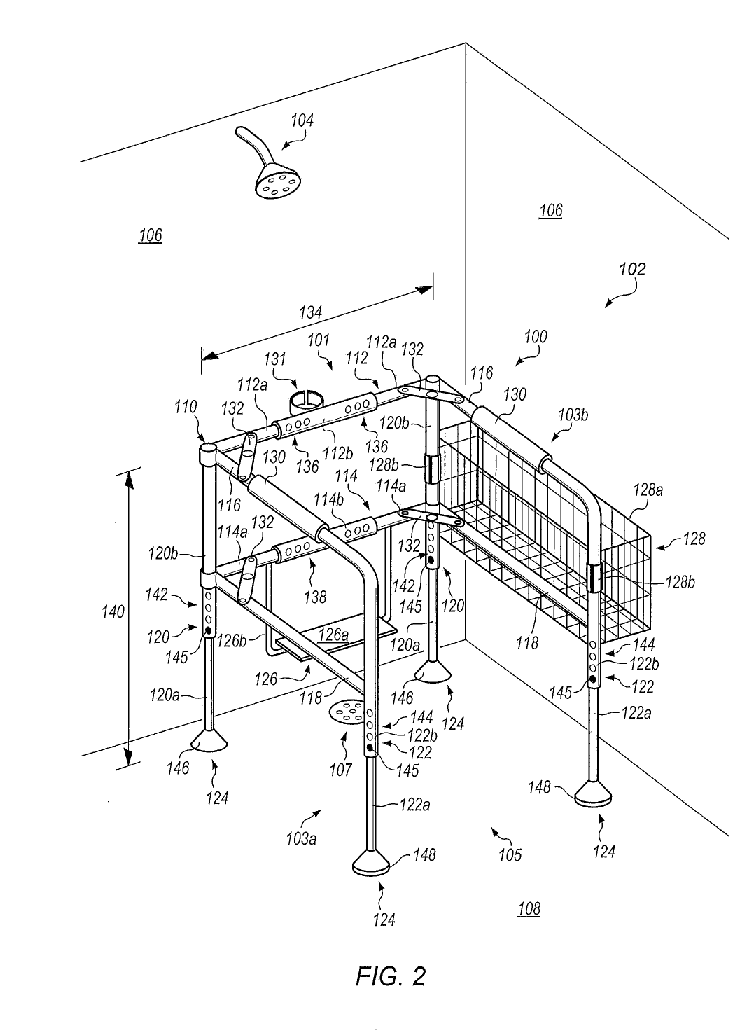

Turning now to FIGS. 1A and 2, depicted is a support 100 in accordance with embodiments of the present technique. FIG. 1 illustrates an embodiment of support 100 in a general walking environment. FIG. 2 illustrates an embodiment of support 100 in a bathing environment. It will be appreciated that each of FIGS. 1A and 2 are provided as exemplary embodiments in exemplary environments, and features of each of the illustrated embodiments described herein may be equally applicable to both of the illustrated embodiments. For example, although FIG. 1A is not illustrated as including a foot support 126 as depicted in FIG. 2, embodiments may include all of or some of the features of FIG. 1A in combination with foot support 126 and/or other features described with respect to FIG. 2. Similarly, the embodiments described with respect to FIG. 2 may include some or all of the features described with respect to FIG. 1A. Accordingly, the particular context used herein for describing the embodiments is intended to be illustrative, and is not intended to limit the scope of the invention.

With regard to FIG. 2, support 100 is provided in a bathing location 102 (e.g., a shower and/or bathtub) having a water source 104 and a drain 107. Shower/bathtub 102 also includes walls 106 and a supporting surface (e.g., bottom floor) 108. In the depicted embodiment, water source 104 includes a shower head assembly. In other embodiments, water source 104 may include multiple shower heads, a shower head assembly attached to a flexible hose, a bath nozzle, or the like. Generally, water source 104 is located on a side wall of shower/bathtub 102, but other arrangements are envisioned. For instance, water source 104 may be located overhead. Walls 106 of shower/bathtub 102 may include the sides of a shower stall, the sides of a bathtub, or the like. Walls 106 are typically formed from porcelain, tile, natural stone, fiberglass, plastics, or the like. Shower/bathtub 102 may include a generally rectangular shape that includes walls 106 extending at least partially upward from supporting surface 108 to help retain and channel water to drain 107. Shower/bathtub 102 may also include a hinged door, sliding door panels, a shower curtain, or the like that facilitates entrance to shower/bathtub 102 while helping to prevent water from escaping shower/bathtub 102 during use. In the case of a bathtub or a shower/bathtub combination, shower/bathtub 102 may include at least one low height wall or wall portion. For example, the low wall portion may extend about fourteen inches upward from base 108 of shower/bathtub 102. Typically a person using such a shower/bathtub may have to step over the low height wall to enter the shower/bathtub.

Support 100 includes a frame that is of sufficient height to be used by a person in a standing position, such as a standing position typically associated with walking and standing while bathing For instance, a portion of support 100 may be of sufficient height that a person may grasp a portion of support 100 with one or both hands, and/or lean against one or more portions of support 100 to provide assistance while maneuvering within and around a bathing environment. The height of support 100 may further enable a person to shower in a standing position without having to take a seated position. During showering, a person may turn, bend over, squat, move forward, back and side-to-side while grasping support 100. Accordingly, a person using support 100 may rest against or otherwise use support 100 while standing, walking, and/or moving about shower/bathtub 102.

Support 100 includes, in some embodiments, a three sided barrier than includes a front side that is to be positioned in front of a person during use, and one or more side portions that are positioned on either side of the person, during use. For example, while standing “in” support 100, the person may stand between two side portions of support 100. When used in a bathing environment, the front side may include a panel of the frame facing a water supply and forming a barrier between the user and the water supply such that a user may enter from a rear side of support 100, opposite from the front side where the water supply is located. Such a configuration may enable a user to support themselves while bending toward the water supply to turn the water supply on/off or the like. Further, support 100 may be moved into different positions. When used as a walker, support 100 may be advanced as a person moves from one location to another. When used in a bathing environment, support 100 may be turned around with a front side facing sideways or away from the water source such that the user can hold onto support 100 while entering or exiting shower/bathtub 102, leaning backwards to rinse their hair, or the like. The addition of feet, such as suction cups or traction pads, may provide additional support that increases stability of support 100 and may help to prevent support 100 from moving, tipping, sliding, or the like during use. For example, support 100 may include feet that provide friction (e.g., suction cups or traction pads) to inhibit unintentional movement of support 100. In some embodiments, the feet may include rollers (e.g., wheels) that facilitate movement and positioning of support 100. In certain embodiments, different types of feet may be used in combination to provide a desired combination of fixation and movement. For instance, suction cups or traction pads may be used in conjunction with rollers to provide both stability and portability. In some embodiments, the feet may be selectively actuated between a configuration to affix support 100 to the supporting surface and a configuration to facilitate movement of support 100.

In some embodiments, support 100 is not substantially permanently affixed to a supporting surface. For example, where used in a bathing environment, support 100 is not permanently affixed to shower/bathtub 102 at any location proximate to shower/bathtub 102. In other words, support 100 is not fixedly attached to shower/bathtub 102. As used herein “fixedly attached” may refer to a coupling of two components (e.g., a support and a shower/tub) that requires a substantial amount of effort or use of tools to remove the attached components from one another. For example, a screw, adhesive, plaster, or similar attachment mechanism may be associated with fixedly attaching components together. Support 100 may be portable or at least semi-portable. Portable may refer to the ability to remove support 100 from a supporting surface with little or no modification to support 100 and without the use of substantial effort or use of tools. For example, in a portable configuration a person may need to adjust feet or similar temporary attachment device before using support 100 when removing support 100 from a shower/bath for use in a bathroom, hallway, or other portions of a home or similar facility, or the like. Such a configuration may enable support 100 to be moved within shower/bathtub 102, moved in-and-out of shower/bathtub 102, and/or used for support outside of and during entry/exit of shower/bathtub 102. The portable nature of support 100 may enable support 100 to be used as a walker, or the like. Further, the portable nature of support 100 may eliminate the need to make any substantially permanent modifications to shower/bathtub 102. For example, installation and use of support 100 may not require the use of a fastener (e.g., a screw, nail, adhesive, plaster or the like) and may not require substantial modifications to a surface of shower/bathtub 102 (e.g., removing tile, drilling of a hole, or the like). Further, the portable nature of support 100 may allow a person to move support 100 such that they can access substantially all portions of shower/bathtub 102. For example, support 100 can be moved within shower/bathtub 102 so that the person can access a shower head, and moved to another location for assistance entering and exiting shower/bathtub 102.

As depicted in FIG. 1A, in some embodiments, support 100 includes a frame 110. Frame 110 includes a plurality of portions that are coupled to one another to from a generally rigid structure that is capable of supporting a person during use, such as while walking and/or bathing. In the illustrated embodiment, frame 110 includes a front portion 101 and two side portions 103a and 103b. Front portion 101 includes a panel that extends between a front end of side portions 103a and 103b. Side portions 103a and 103b include upper side members 116, lower side members 118, intermediate side members 119, front vertical members 120, rear vertical members 122, and feet 124.

As depicted in FIG. 2, in some embodiments, frame 110 includes upper front cross member 112, lower front cross member 114, upper side members 116, lower side members 118, front vertical members 120, rear vertical members 122, and feet 124. Support 100 also includes a foot support 126, an accessory container 128, pads/grips 130, and a water supply support 131.

In some embodiments, support 100 includes a three sided barrier where front portion 101 is to be positioned in front of a person, and side portions 103a and 103b are to be positioned on either side of the person, during use. For example, FIG. 1B illustrates a top view of support 100 of FIG. 1A in an opened position. As depicted in FIG. 1B, frame 110 includes a substantially rectangular shape. Front portion 101 and side portions 103a and 103b are arranged substantially orthogonal to one another in the opened position to form a substantially rectangular shaped three-sided barrier. In some embodiments, members 112-122 are oriented substantially orthogonal to one another during use. For example, as depicted in FIG. 2, upper front cross-member 112 and lower front cross-member 114 are oriented generally perpendicular to upper side members 116, lower side members 118, and vertical members 120. With respect to upper front cross-member 112 the two upper side members 116 extend from substantially at or near the ends of front cross-member 112 in a substantially horizontal orientation toward a rear of the support 100. Similarly, with respect to lower cross-member 114 the two lower side members 118 extend from substantially at or near the ends of front lower cross-member 114 in a substantially horizontal orientation toward a rear of support 100.

While positioned “in” support 100, a person may stand between two side portions 103a and 103b of support 100. A front side of support 100 may be defined as the location that a person typically faces while using support 100 and a rear side of support 100 may be defined as a location where a person enters support 100 for use. In the illustrated embodiment, a rear side of support 100 includes a clear path 105 (e.g., no cross members) such that a person can step into and stand in a central portion of support 100 located between side portions 103a and 103b. Further, the front of support 100 may be defined as the side opposite an opening to enter support 100. In other words, a user can enter at the rear of support 100 and the front is a side of support 100 is opposite the rear. When support 100 is used in a bathing environment, front side of support 100 may be defined as a portion of support 100 that faces a water supply extending from a wall of shower/bathtub 102, and a rear side of support 100 may be defined as a portion of support 100 opposite the front and/or that is facing substantially away from a water supply of the shower/bathtub. For instance, front portion 101 may be located between a water source and the user when support 100 is in use.

In some embodiments, support 100 may include front and/or side portions having at least some curvature. For example, as depicted in FIG. 1B, side portions 103a and 103b include a concave curvature facing the center of support 100, where a person is expected to stand during use. The curvature may provide an ergonomic shape that is desirable for persons grasping side portions 103a or 103B during use. For example, the curvature may accommodate the natural position of a persons hands, eliminating the need to rotate their hand/wrist to grasp otherwise straight cross members of the respective sections. Further, the curvature may provide additional comfort/security to a user by at least partially wrapping about the person while standing in support 100. Moreover, such a curvature may provide more room in the central-interior of support 100, while maintaining a smaller overall footprint. For example, the central portions of support 100 may be wider to enable larger persons to use the walker, while maintaining narrower front and rear ends that facilitate movement of support 100 in smaller tight space. In some embodiments, front portion 101 may include similar concave curvature.

In the illustrated embodiments, front portion 101 and side portions 103a and 103b provide a three-sided barrier that includes support members that can be grasped by a person while in a standing position. A three-sided barrier is formed from three substantially planar or curved sections (e.g., front portion 101, and side portions 103a and 103b) arranged substantially orthogonal to one another, to create a U-shaped support (see FIG. 2A). In other embodiments, a three-sided barrier may be formed from more or less than three members or sections. For example, a single c-shaped member or section may provide a three-sided barrier that extends/wraps substantially around a user during use. In some embodiments, frame 110 includes a C-shaped or arced frame that spans from one side of the user to another. In some embodiments, the angle of the c-shaped member comprises an arc anywhere from about ninety degrees to about two-hundred seventy degrees. In other words, from about one-forth of a circular area to about three-fourths of a circular area. In such an embodiment, a person can enter via an opening in the arc or c-shaped frame 110, and can stand in a central area of the arced or c-shaped circular frame 110 and grasp portions of frame 110, such as an arced top or front cross-member 112. Other embodiments may include additional configurations of members and sections coupled to one another to provide a three-sided barrier.

In the illustrated embodiments, support 100 includes four vertical members located in a generally rectangular arrangement and each oriented in a substantially vertical direction. More specifically, two of vertical members 120 at the front of support 100 (e.g., front vertical members 120) extend from the intersection of upper front member 112 and front ends of upper side members 116 through portions of front portion 101 (e.g., in FIG. 2, the intersection of lower front member 114 and front ends of lower side members 118) and extend downward to feet 124 that contact support surface 108, such as a walkway, floor, or bottom surface of a shower/bathtub, during use. Similarly, two of vertical members 122 at the rear of support 100 (e.g., rear vertical members 122) extend from the rear ends of upper side members 116 to rear ends of lower side members 118, and extend downward to feet 124 that contact support surface 108, such as a walkway, floor, or bottom surface of a shower/bathtub, during use. As depicted in FIG. 2, in some embodiments, additional support members 132 may be located in the respective corners formed between upper front member 112 and upper side members 116.

In some embodiments, support 100 can be folded into a collapsed position. For example, in the illustrated embodiments, side members 116 and 118 arc pivotably coupled to front vertical members 120 such that they can be rotated about a longitudinal axis of vertical members 120. In the illustrated embodiments, side portions 103a and 103b can be rotated inward toward front portion 101 of support 100. FIG. 1C illustrates support 100 of FIG. 1A in a folded/contracted configuration. In some embodiments, both side portions 103a and 103b are folded toward the front of support 100 such that support 100 is folded into a substantially flat/closed/collapsed configuration. Folding may be helpful for storing or transporting support 100. In the illustrated embodiment of FIG. 1A, support 100 sides 103a and/or 103b may be locked into the folded/closed or unfolded/opened positions. In some embodiments, locks may be actuated by pressing one or more lock actuation mechanisms, such as buttons or latches 133. In the illustrated embodiment of FIG. 2, members 132 include hinged members that can be collapsed to provide support 100 in a folded position, and extended to provide support 100 in an opened position for use. In some embodiments, support members 132 may be locked or otherwise biased or locked into one or both of the folded or extended positions. Locking support members 132 during use may help to prevent support 100 from folding/closing inadvertently.

Other embodiments may include additional members for providing additional support. For example, the embodiment illustrated in FIG. 1A includes intermediate side members 119 that each extend diagonally between an upper portion of vertical members 120 to a mid-portion of vertical members 122. Intermediate side members 119 may provide additional structural strength and rigidity, may provide an additional ergonomic location for a user to grasp, and/or may provide internal channels for internally routing cable/cord/wire/string/line/chain/rod or similar elongated element (herein after referred to as a “cable” or “cables”) used to actuate feet 124, as described in more detail below. Further, an additional bottom front/side member may extend between ends of members at or near feet 124. In some embodiments, a member may not extend between portions in the rear of support 100 (e.g., may not extend between vertical members 122), thereby providing a clear path for a person to move into a center of support 100 during use.

In some embodiments, support 100 may be adjustable in one or both of height and width. Adjustment of a width may enable support 100 to vary in size to fit securely within showers/bathtubs of varying dimensions. For example, the width may be expanded or contracted such that support 100 rests on a bottom surface of the shower/bathtub, and/or has a portion that contacts or is substantially near the walls of shower/bathtub such that support 100 can not move a substantial distance in a lateral direction (e.g., side-to-side), and may not be as subject to tipping over. For instance, the width may be adjusted to slightly less than a dimension typically associated with a width of a bathtub, such as about twenty inches.

In some embodiments, a width 134 of support 100 may be adjusted by adjusting a width of front portion 101. For example, as depicted in FIG. 2, adjusting a length of one or both of front members 112 and 114. In some embodiments, front cross members 112 and 114 each include a telescoping configuration that enables the length of each member to be adjusted by sliding one portion of each member into another portion of the member. For example, in the illustrated embodiment, upper front member 112 includes first portions 112a having an outer diameter that is capable of fitting within an inner diameter of second portion 112b. In the illustrated embodiment, one or both of first portions 112a may be slid relative to second portion 112b to adjust an overall width 134 of support 100. Further, front support 112 may include a locking mechanism 136 to secure support 100 at a given width. In the illustrated embodiment, locking mechanism 136 includes holes and a biased pin that extends into the holes and can be depressed during adjustment. Locking mechanism 136 may include similar devices, such as tubes that can be rotated relative to one another to lock or unlock, threaded tubes that can be rotated relative to one another to change the width, a clamp/lever that can be tightened or loosened, a combination thereof, or the like. Lower front member 114 includes similar features including first portions 114a, second portions 114b, and locking mechanism 138.

Adjustment of a height may enable support 100 to vary in size for use by persons of differing heights, for use while bathing in different positions, and the like. For example, the height may be extended or reduced such that supports rest on a bottom surface of the shower/bathtub and extends upward from the bottom surface such that it may be grasped by user while standing. The height of support 100 may be adjusted such that a member at an upper portion of support 100, such as upper front and side members 112, and 116, are positioned at a dimension typically associated with a height for grasping by a user while showering (e.g., a height of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60 or more inches). In the illustrated embodiments of FIGS. 1A and 2, a height 140 of support 100 may be adjusted by adjusting a length of one, more than one, or all of front and rear vertical members 120 and 122. Vertical members 120 and 122 may each include a telescoping configuration that enables the length of each member to be adjusted by sliding one portion of each member into another portion of the member. More specifically, in the illustrated embodiment, each of vertical members 120 and 122 include lower portions 120a and 122a having an outer diameter that is capable of fitting within an inner diameter of upper portions 120b and 122b, respectively. In the illustrated embodiment, first portions 120a and 122a may be slid relative to second portions 120b and 122b to adjust an overall height 140 of support 100. Further, each vertical support 120 and 122 may include a locking mechanism 142 and 144 to secure support 100 at a given height. In the illustrated embodiment, locking mechanisms 142 and 144 include holes and a biased pin 145 that extends into the holes. The pin can be depressed to allow adjustment. Locking mechanisms 142 and 144 may include similar devices, such as tubes that can be rotated relative to one another to lock or unlock, threaded tubes that can be rotated relative to one another to change the height, a clamp/lever that can be tightened or loosened, a combination thereof, or the like. Each of vertical supports 120 and 122 may be adjusted independent of one another. Such an adjustment may enable adjusting support 100 for use on unlevel surfaces, such as when a portion of support 100 is located within shower/bathtub 102 and a portion is located outside of shower/bathtub 102 as discussed in more detail below with respect to FIG. 8.

In some embodiments, feet 124 may include a portion of support 100 that interfaces with supporting surfaces, such as floors or the interior of a shower/bathtub. Feet 124 may include devices that are configured to increase friction or otherwise aid in securing support 100 in place and/or prevent support 100 from inadvertently slipping or moving. In some embodiments, feet 124 may provide a temporary coupling of support 100 to a surface. In some embodiments, feet 124 may include suction cups, pads, blocks, and the like, For example, in the illustrated embodiments, feet 124 at the lower ends of vertical members 120/122 may include suction cups 146. In some embodiments, suction cups 146 may include suctions cups that stick to a surface by pressing them downward to evacuate air from their interior volume (or otherwise evacuating air) to create a resulting suction that forms when the suction cup attempts to return to its unbiased/undeformed state. In some embodiments, a suction cup includes a conical, hemispherical or similar depression such that when the suction cup is pressed down against a surface, it is deformed to evacuate air from within the depression. The evacuation of air and the deformity of the suction cup creates a bias or restoring force as it attempts to return to its undeformed state. A seal between the suction cup and the surface prevents air from returning to the depression and holds the suction cup in place against the surface. In some embodiments, suction cup 146 may include a substantially flat flexible disc-shaped member that creates a suction when, while the disc-shaped member is resting on a supporting surface, a center portion of the disc shaped member is drawn away from the supporting surface to induce a negative pressure against the supporting surface, thereby inducing a suction.

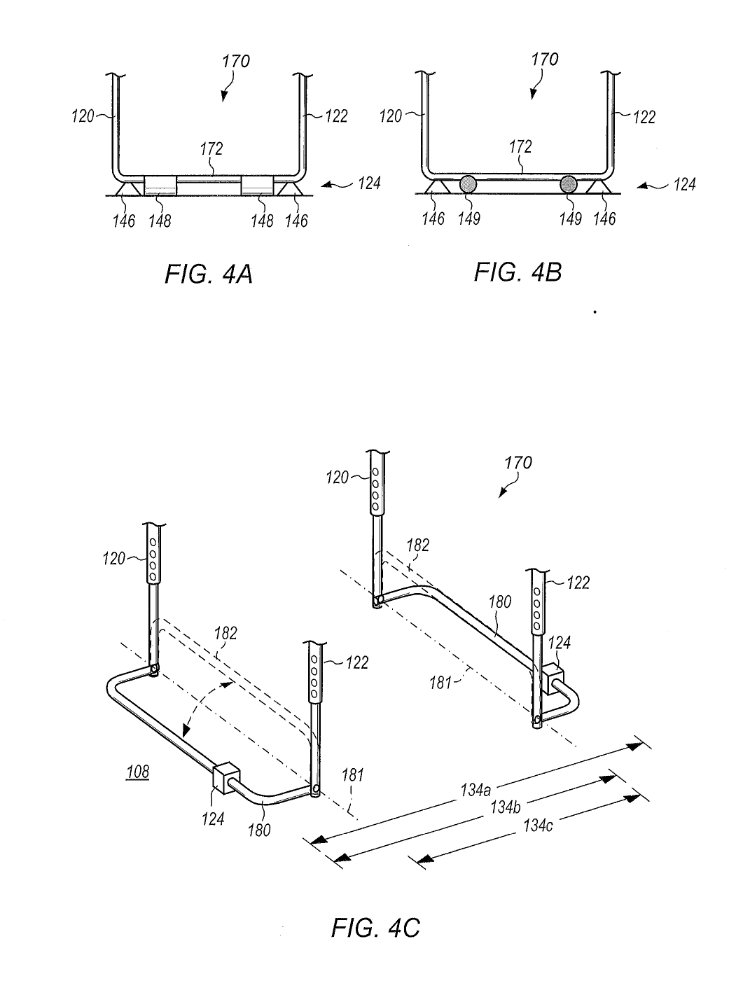

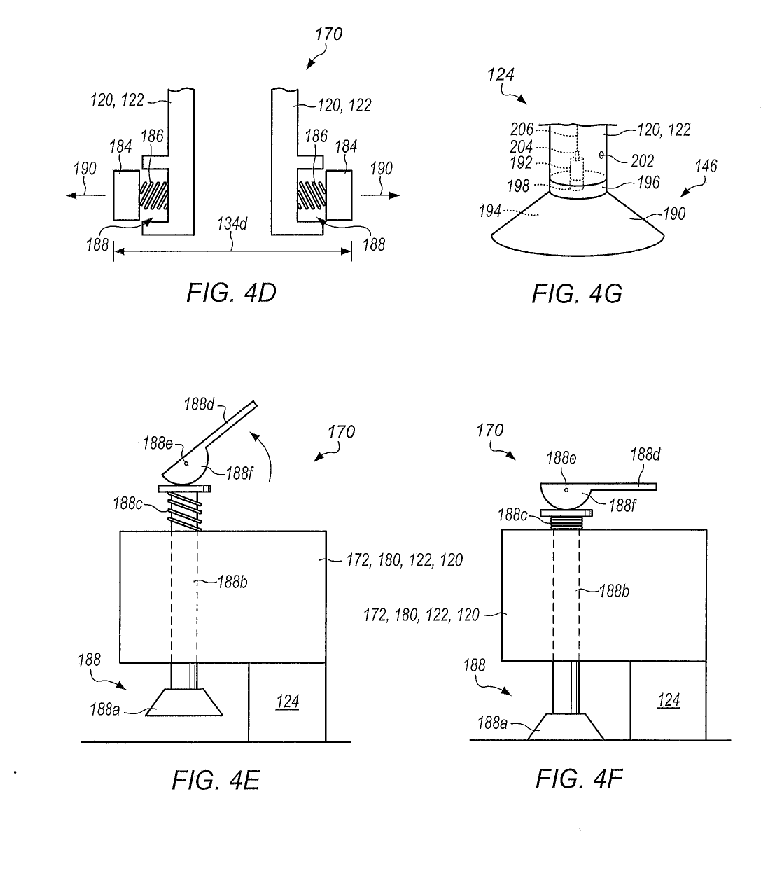

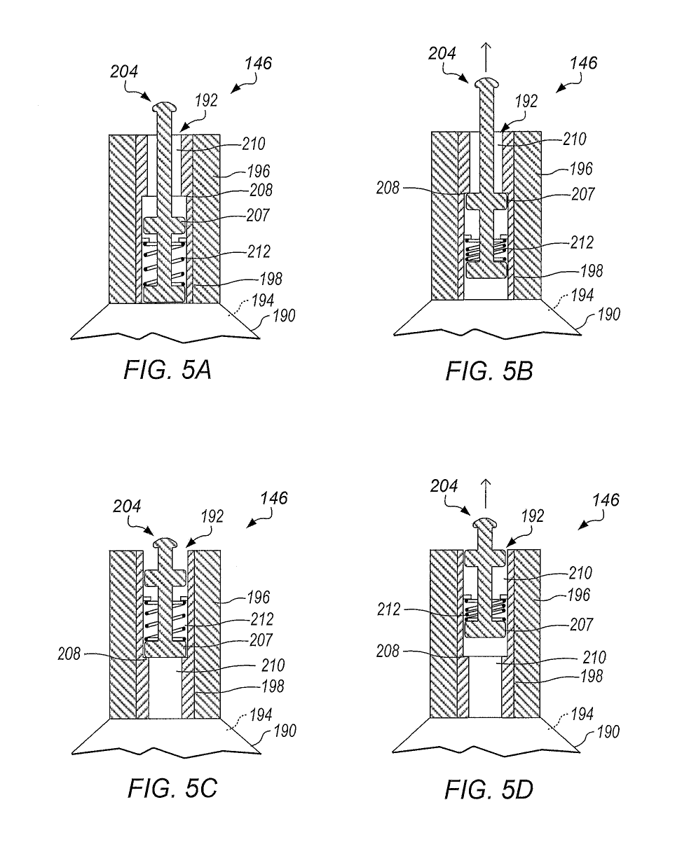

Feet 124 or similar devices may be actuated in accordance with one or more embodiments of the present technique. In some embodiments, suction cups may include a lever or similar device that can be manually operated to urge the evacuation of air and/or to otherwise induce a negative pressure, to create a suction that holds the suction cup in place (e.g., coupled the suction cup to a supporting surface). In some embodiments, suction cups may include a pneumatic pump or similar device that can be operated to evacuate air and automatically create a suction that holds the suction cup in place. Suction cups may provide a temporary coupling that does not require the use of significant effort or additional tools to couple or uncouple them to a supporting surface. In some embodiments, feet 124 may be actuated between a state that facilitates fixing the position of support 100 and a state that facilitates movement of support 100. In certain embodiments, at least one of feet 124 includes a suction cup having a valve (e.g., a Schrader style valve) that can be provided in a closed position to seal the interior volume of the suction cup to facilitate fixing the support to a surface, and can be provided in an open position to open the interior volume of the suction cup such to facilitate the suction cup and the support being movable on the supporting surface. Actuation mechanisms are illustrated and described in more detail below with respect to at least FIGS. 4E-5D.

In some embodiments, feet 124 may include pads, or similar members that provide increased friction to assists in temporarily coupling or securing support 100 to a surface. For example, in the illustrated embodiment of FIG. 2, feet 124 at lower ends of vertical members 122 include pads 148. In some embodiments, pads may include rubber pads, felt pads, adhesive pads, or the like that are configured to grip a complementary surface. These may be referred to as non-slip pads. Feet 124 may also include materials and or surface designs (e.g. treads) that may help to repel or channel water away from contact points between feet 124 and a surface to reduce the likelihood of support 100 slipping or otherwise inadvertently moving during use.

In some embodiments, one or more of feet 124 may include devices that reduce friction with a supporting surface such that support 100 can easily be moved or repositioned. In some embodiments, feet 124 may include rollers, such as wheels. For example, one or more of feet 124 may include fixed wheels that are oriented in a given direction, such as wheels aligned to roll in a forward or backward direction. In some embodiments, one or more feet 124 may include caster wheels. Caster wheels may include pivoting/swiveling wheels that are capable of pivoting or swiveling about a vertical axis such that their orientation is variable. In some embodiments, one or more of feet 124 may include a wheel that includes one or more disc-shaped rolling elements. In some embodiments, one or more of feet 124 may include a wheel that includes one or more spherical-shaped rolling elements. In some embodiments, the rolling element may be locked in position such that it can not roll or is at least inhibited from rolling. For example, feet 124 may be coupled to a brake lever or similar actuation mechanism that can be depressed by a user to lock the wheel to prevent it from rolling. In some embodiments, the lever may include a pedal like device mounted to the wheel such that a user can lock and unlock the wheel by stepping on or lifting the lever up with their hand or foot. In some embodiments, an actuation mechanism may be provided elsewhere on support 100. For example, a hand brake or button may be provided within a user's reach, such as on or near support member 116. Thus, a user may simply depress the lever, handle or button to lock/unlock the wheel.

In some embodiments, any combination of types of feet 124 may be provided. For example, in the illustrated embodiment of FIG. 2, front feet 124 include suction cups 146 and rear feet include pads 148. In some embodiments, all of feet 124 may include suction cups 146, as depicted in FIG. 1A. In some embodiments, all of feet 124 may include pads 148. In some embodiments, all of feet 124 may include wheels. Other embodiments may include any combination thereof. For example, front feet 124 may include wheels or other devices that facilitate movement and back feet 124 include pads and/or suction cups or other devices that can facilitate creating a friction to facilitate fixing a position of support 100. Such a configuration may enable a user to lift up on the rear of support 100 such that it is easily movable on front feet 124, and simply lower the rear feet 124 when needed to secure support 100 to a surface.

In the illustrated embodiment of FIG. 2, support 100 includes foot support 126. Foot support/rest 126 may provide a stable location for a person to rest their foot while showering or bathing (e.g., while washing their leg and foot). A person having difficultly lifting their foot and keeping it raised for bathing may pick their foot up and rest it on foot rest 126 such that they can wash their foot with reduced effort. In the illustrated embodiment, foot rest 126 includes a platform 126a that is located less than the height 140 from bottom surface 108 of shower/bathtub during use of support 100. In some embodiments platform 126a may be located at or between about twelve and eighteen inches from the bottom of support 100 (e.g., from feet 124 and/or a surface support 100 rests on). In the illustrated embodiment, platform 126a is supported by a u-shaped member 126b that extends downward from lower front member 114. In some embodiments, foot support 126 may include a platform integral with u-shaped member 126b, or may include only u-shaped member 126b such that a person can simply place their foot onto the lower cross-member of the u-shaped member 126b. In other embodiments, foot support 126 may be located at another portion of support 100, such as extending from one or both lower side members 118. Foot support may rotate about u-shaped member 126b or otherwise pivot or fold to allow folding and or collapsing of support 100.

In some embodiments, support 100 may include a seat. In the bathing environment, a seat may provide a user the option of standing or sitting while bathing. For example, support 100 may include a seat that extends between lower side members 118. In some embodiments, the seat may be removably attached (e.g., clipped) to a portion of support 100 such that a user may easy install and uninstall the seat. In some embodiments, the seat may be provided at a front portion of support 100 such that a user can enter from the rear of support 100 without removing the seat. In some embodiments, the seat may be located at or near a rear portion of support 100. In such embodiments, the seat may be removed as a user enters support 100 from the rear, and may be installed or reinstalled at or near the rear of support 100 while the user is in the center area of support 100, thereby enabling the user to squat into the seat while facing the water source in a seated position.

In the illustrated embodiment of FIG. 2, support 100 includes accessory container 128. Accessory container may be used to hold bathing supplies, such as soap, shampoo, a sponge, a washcloth, a brush, or the like. In the illustrated embodiment accessory container 128 includes a basket 128a having four sides and a bottom. Accessory container 128 may be removable from support 100. In the illustrated embodiment, accessory container 128 includes clips 128b that are removably coupled to vertical support members 120 and 122. In the illustrated embodiment, clips 128b include c-shape protrusions that can be snapped around the external diameter of vertical members 120 and 122. Other embodiments may include other devices, such as hooks that can be used to couple accessory container 128 to other portions of support 110. In the illustrated embodiment, accessory container 128 is located on only a right side of support 110. Other embodiments may include any number of accessory containers 128 located on one or more sides of support 100. For example, an accessory container may be located on any combination of a right, left, front, or rear of support 100. Further, accessory container 128 may include additional features, such as hooks, fasteners or similar features for hanging bathing cloths, brushes, back scrubbers, and the like.

In the illustrated embodiment of FIG. 2, support 100 includes pad/grip 130. More specifically, pads/grips 130 are located along a length of upper side members 116. Pad/grips 130 may provide for a person to easily grasp support 100 by reducing the likelihood of their hand slipping. In some embodiments pad/grips may include foam or rubber sleeves fit over members 116, formed integral with members 116, adhesively attached to members 116, or otherwise secured to members 116. Other embodiments may include any number of pads/grips located on other portions of support 100. For example, a pad/grip may be provided on foot support 126.

In the illustrated embodiment of FIG. 2, support 100 includes a water supply support 131. Water supply support 131 may be used to hold a water supply device, such as a shower head or a portable shower head that is attached to a hose and can be moved about a shower/bathtub. In such an embodiment, a person may place the shower head into water supply support 131 such that the water supply terminates proximate a portion of support 100 and/or themselves such that they may easily move or otherwise control the water being showered onto them. For example, the shower head can be removed or redirected to direct water to a certain location. In the illustrated embodiment, water supply support 131 includes a c-shaped protrusion extending from upper front support member 112. Water supply support 131 includes a cavity in which water supply device (e.g., a portable shower head) or similar device can be set. For example, a user could place a hose or shower head into supply support 131 temporarily while moving about. The opening in the c-shaped protrusion may enable a hose to be passed into the center of water supply support 131 such that it may accommodate a hose of a portable shower head. Water supply support 131 is substantially at the height of upper front member 112. During use, the water supply device can be secured in water supply support 131 to direct water in a general direction or may be removed for use in other locations to direct water in differing directions. One or more water supply supports 131 may be employed on various locations of support 100.

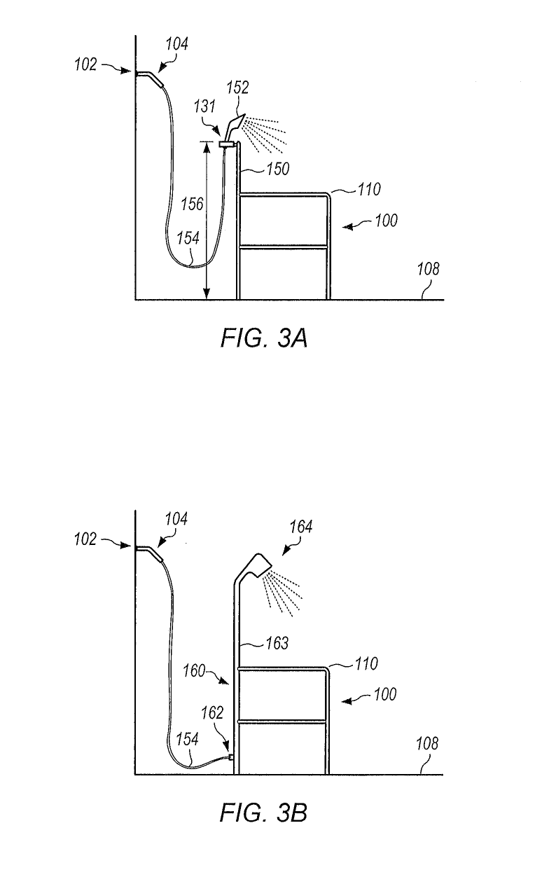

FIG. 3A illustrates water supply support 131 in accordance with one or more embodiments of the present technique. In the illustrated embodiment, water supply support 131 provides for locating a water supply device (e.g., a portable shower head) or similar device at a significant height. For example, water supply support 131 may provide for securing a water supply device at a level similar to that associated with a traditional shower head. In some embodiments, the height of water supply support 131 may be capable of supporting a water supply device at a convenient height for showering (e.g., about five feet, six feet, seven feet, or more from a from the bottom surface of shower/bath 102). In the illustrated embodiment, support 100 includes a vertical water supply support member 150 that extends in an upward direction from a member (e.g., upper front member 112) of support 100, providing a water supply device 152 (e.g., portable shower head connected to water supply 104 via a hose 154) at a sufficient height 156 for showering while standing (e.g., at about five feet, six feet, seven feet, or more from a bottom surface 108 of shower/bath 102). Other embodiments may include a water supply support 131 that can be adjusted in height. For example, vertical water supply support member 150 may be capable of telescoping between different lengths such that height 156 of water supply support 131 and water supply device 152 can be modified. Other embodiments may include placement of a water supply support 131 on other locations of support 100, such as on upper side members 166 of support 100.

FIG. 3B illustrates an embodiment of support 100 that includes an integral water supply 160 in accordance with one or more embodiments of the present technique. In the illustrated embodiment, water supply 104 is coupled to an inlet 162 of support 100 via hose 154 and water is internally routed via a conduit 163 to an outlet 164. Such an embodiment may enable simplified direction of water toward a user. Further, the added connection of a hose and the weight of the water being routed internally may help to increase stability of support 100 during use. In some embodiments, inlet 162 may include a fluid coupler, such as a threaded pipe fitting, a quick disconnect, or the like, capable of mating with a complementary fitting on the end of hose 154. Water passing through inlet 152 may be routed via conduit 163. In some embodiments, conduit 163 may include a hose coupled to support 100, an additional hollow tubing coupled to a portion of support 100, or may include an integral conduit, such as the interior of one of the support members used to form support 100 (e.g., vertical members 120, 122, front support members 112, 114, water supply support member 150, or the like). Water may exit via outlet 164. In some embodiments, outlet 164 may include a shower head or the like. As depicted, outlet 164 may be located at a sufficient height for showering while standing. In other embodiments, outlet may be located at a lower position and/or adjustment between a multiple heights, as described above with regard to FIG. 2A. For example, conduit 163 may be telescoping to enable variable height adjustment of outlet 164. In some embodiments, conduit may be formed via a hollow internal cavity internal to a molded portion of support 100. For example, water may be route through a hollow internal cavity of a barrier portion of support 100.

FIG. 4A illustrates an alternate embodiment of a lower portion 170 of support 100. In the illustrated embodiment, a bottom horizontal member 172 extends between locations at or near the lower ends of front vertical supports 120 and rear vertical supports 122. Such an embodiment may provide increased strength with regard to support 100 and may help to secure vertical supports relative to one another. Further, the addition of bottom horizontal member 172 may provide one or more additional locations for feet 124. For example, in the illustrated embodiment, four feet 124 are provided including two suction cups 146 and two pads 148 disposed between suction cups 146 and along the length of bottom horizontal member 172. Other embodiments may include any number of feet 124 and combination of types of feet 124 disposed along bottom horizontal member 172. For example, in some embodiments, rollers may be provided in place of pads 148 and/or suction cups 146. FIG. 4B illustrates an embodiment that includes rollers 149 used in combination with suction cups 146. Rollers 149 may include wheels or similar devices that can be configured to facilitate movement of support 100.

FIG. 4C illustrates a lower portion 170 of support 100 in accordance with one or more embodiments of the present technique. In the illustrated embodiment, lower portion 170 includes an adjustable width. More specifically the width is adjustable between at least three overall widths. In the illustrated embodiment, lower portion 170 includes two members that can be adjusted between multiple positions to vary the overall width 134 of support 100. For example, support 100 includes two u-shaped lower horizontal members 180 that are each rotatably coupled to lower end of vertical members 122 and 120. Each lower horizontal member 180 may be rotatable about an axis 181 that extends between the locations at or near the lower ends of a pair of vertical member (e.g., vertical members 120 and 122). In a first, extended position, each u-shaped lower horizontal member 180 may be rotated outward, as depicted, such that u-shaped lower horizontal member 180 is substantially parallel to a supporting surface (e.g., bottom surface 108) and extends outward from support 100. In a second, unextended/retracted position, each u-shaped lower horizontal member 180 may be rotated inward into a retracted position, as depicted by dashed lines and arrows 182, such that u-shaped lower horizontal member 180 is substantially parallel to and flush with vertical members 122 and 120 and does not substantially extend outward from support 100. In a first embodiment, both lower horizontal members 180 may be extended to provide an overall maximum width represented by 134a. In a second embodiment, only one of the two lower horizontal members 180 may be extended to provide an overall intermediate width represented by 134b. In a third embodiment, both lower horizontal members 180 may be unextended to provide an overall minimal width represented by 134c. Other embodiments may include partial extension of one or both of lower horizontal members 180 to provide a variety of overall widths. Such an embodiment may provide for adjustment of width 134 to approximately match or be closer to a width of a shower/bathtub (e.g., between sides 106) and thereby add stability that can help to reduce side-to-side movement of support 100 and reduce the likelihood of support 100 tipping over. As depicted, one embodiment may include feet 124 coupled to lower horizontal member 180. Feet 124 may provide an additional traction and/or increase portability between the support 100 and a surface that support 100 rests upon. For example, feet 124 may include suction cups 146, pads 148 and/or rollers 149.

FIG. 4D illustrates an alternate embodiment of a lower portion 170 of support 100 in accordance with one or more embodiments of the present technique. In the illustrated embodiment, lower portion 170 includes an adjustable width. More specifically, lower portion 170 includes engaging members 184 that can be translated laterally to increase or decrease the effective width of lower portion 170 and potentially, the overall width 134 (see FIG. 1) of support 100. In the illustrated embodiment, vertical members 120/122 include a biasing member 186 located in a recess 188 at or near their lower ends. In the illustrated embodiment, vertical members 122 are depicted, but similar techniques may be applied at other members (e.g., vertical members 120 or bottom horizontal member 172) or other portions of support 100. During use, engaging members 184 may translate (e.g., slide) in a lateral direction into and out of recess 188 to effectively increase or decrease an effective width 134d. Biasing members 186 may provide a force that urges engaging members 184 in an outward lateral direction, in the direction of arrows 190. During use, expansion of engagement members 184 in an outward lateral direction may increase the overall effective width 134d to approximately match or be closer to a width of a shower/bathtub (e.g., between sides 106) and thereby reduce side-to-side movement of support 100 and reduce the likelihood of support 100 tipping over. In some embodiments, biasing members 186 may include springs (e.g., linear springs), or a similar device that provides a restoring force to urge the engaging members 184 in an outward lateral direction and potentially into engagement with a surrounding surface. Engagement members 184 may be formed from or include an engagement surface configured to contact a wall that is formed in a similar manner to feet 124 described above (e.g., to increase traction and/or to facilitate movement to improve portability). For example engagement members 184 may include suction cups.

FIGS. 4E and 4F illustrate lower portion 170 of support 100 in accordance with one or more embodiments of the present technique. In the illustrated embodiment, lower portion 170 includes a dynamically positionable suction cup 188 (e.g., dynamic suction cup 188) in accordance with one or more embodiments of the present technique. Dynamic suction cup 188 may be movable between two or more position, such as an engaged position (e.g., a locked position) and a disengaged position (e.g., an unlocked position). In some embodiments movement of dynamic suction cup 188 between positions is the result of rotating a lever, knob, or similar actuating mechanical device configured to urge dynamic suction cup 188 in a given direction. In the illustrated embodiment, dynamic suction cup 188 is depicted within a member, such as bottom horizontal members 172, u-shaped lower horizontal members 180, front vertical members 120, rear vertical members 122, or another portion of support 100. Dynamic suction cup 188 includes a suction cup 188a, a longitudinal member 188b, a biasing member 188c, and a lever 188d. In an unlocked position, lever 188d is rotated counterclockwise about its axis 188e (e.g., a pin) such that a narrow portion of a lobe 188f extending therefrom faces longitudinal member 188c thereby enabling a biasing member 188c to urge longitudinal member 188b upward into contact with lobe 188f and disengaging/unlocking suction cup 188a from a surface, as depicted in FIG. 4E. During use, movement of lever 188d about axis 188e (e.g., a pin) in a clockwise direction rotates thicker portion of lobe 188f into contact with a top of longitudinal member 188b, thereby urging longitudinal member 188b and suction cup 188a downward into contact/engagement with a surface, as depicted in FIG. 4F. Biasing member 188c may include a linear spring, or the like configured to provide a biasing force such that suction cup 188a is urged to disengage the surface when the mechanism is unlocked by user. As depicted, some embodiments may include additional feet 124, such as pads 148. In some embodiments, the addition of feet 124, such as suction cups 146 and/or pads 148, may help to reduce the likelihood of support 100 rocking, sliding, or tipping even when dynamic suction cup 188a is disengaged/unlocked. In some embodiments, the addition of feet 124, such as rollers 149, may help to facilitate movement of support 100 when dynamic suction cup 188 is disengaged/unlocked. In some embodiments, rollers 149 may include lockable rollers that are locked when dynamic suction cup 188 is engaged/locked and are unlocked when dynamic suction cup is disengaged/unlocked. In some embodiments, actuation of rollers 149 and dynamic suction cup 188 may occur in unison. For example, dynamic suction cup 188 may be engaged/disengaged and roller 149 may be locked/unlocked simultaneously via movement of lever 188d. In some embodiments, 188 may be engaged remotely. For example, an actuation mechanism located on an upper portion of frame 110 may be actuated by a user to pull up on lever 188d (e.g., via a cable).

FIG. 4G illustrates one of feet 124 including a valve actuated suction cup 146, in accordance with one or more embodiments of the present technique. Foot 124 is coupled to a lower end of a vertical member 120, 122. Other embodiments may include foot 124 coupled to other portions of support 100, such as bottom horizontal member 172 of FIGS. 4A and 4B. In the illustrated embodiment, suction cup 146 includes a sealing member/cup 190 and a valve 192. Sealing member 190 may include a conical shaped resilient/flexible member (e.g., flexible cup) that is capable of sealing with a complementary supporting surface, such as the porcelain surface of a bathtub or a tile floor. A concave portion of sealing member 190 defines an interior volume 194 of suction cup 146. During use, suction cup 146 may stick to a supporting surface when it is pressed downward, toward the supporting surface, thereby deforming sealing member 190 and evacuate air from interior volume 194 to generate suction. The suction may be a result of sealing member 190 attempting to return to its unbiased/undeformed state. That is, a seal between sealing member 190 and the supporting surface prevents air from returning to the interior volume 194 and holds the suction cup 146 in place against the supporting surface.

As depicted in FIG. 4G, sealing member 190 may include a cup portion (“sealing cup”) 194 and an upper body portion 196. Upper body portion 196 may be formed at an apex of cup portion 194. In some embodiments, upper body portion 196 is formed of a rigid or semi-rigid material that is disposed in a recess of support 100. For example, in the illustrated embodiment, upper body portion 196 forms a cylindrical plug that is inserted into an open end of vertical members 120, 122. In some embodiments, an adhesive or mechanical fastener may be used to secure body portion 196 to vertical members 120,122. Body portion 196 may also include an orifice 198 that extends between an interior volume 194 and an exterior volume (e.g., an interior of vertical members 120, 122). Valve 192 may be coupled to (e.g., disposed) in orifice 198 to regulate the flow of air into and out of interior volume 194 via orifice 198. In some embodiments, valve 192 may include an insert that is threaded or otherwise inserted into orifice 198. In some embodiments, valve 192 may be formed integral to orifice 198. For example orifice 198 may be formed including a sealing flange, and the inner workings of valve 192 may be disposed directly into orifice 198. In some embodiments, a vent 202 may be provided in vertical members 120, 122 to ensure that air can flow into and out of the internal space of vertical member 120, 122. In some embodiments, a vent may not be needed. For example, no additional vent may be provided where vertical members 120, 122 include other openings.

In some embodiments, valve 192 may be actuated between a closed position and an open position. The closed position may inhibit the flow of air between interior volume 194 and an exterior volume, and the open position may facilitate the flow of air between interior volume 194 and an exterior volume. The open position may enable the equalization of pressure between interior volume 194 and the exterior volume to reduce or eliminate coupling of suction cup 146 to the supporting surface. For example, when suction cup 146 is coupled to a supporting surface, valve 194 may be closed to completely block air from entering interior volume 194 via the orifice, thereby maintaining a negative pressure (e.g., suction) with interior volume 194 that facilitates suction cup 146 remaining coupled to the supporting surface. Valve 194 may be opened to allow air to enter interior volume 194 via the orifice, thereby equalizing the pressure in the interior volume 194 and eliminating the suction induced by sealing member 190, and effectively uncoupling suction cup 146 from the supporting surface.

In some embodiments, valve 192 may include an actuation mechanism for opening and closing of valve 192. For example, valve 192 may include a plunger 204 that can be depressed or released to open or close valve 192. In some embodiments, plunger 204 may be operated remotely. For example, in the illustrated embodiment, an actuation member 206 is coupled to and extends from plunger 204. In some embodiments, actuation member 206 includes a cable/cord/wire/string/line/chain/rod or similar elongated element (hereafter referred to as a “cable”) that can be used to pull plunger 204 to open or close valve 192. For example, actuation member 206 may include a cable that is coupled to a brake lever style actuation mechanism that can be depressed by the user to pull-up on plunger 204 to open or close valve 192.

Valve 192 may be biased into an opened or closed position. In some embodiments, valve 192 is biased into an opened position such that suction cup 146 does not effectively couple with a supporting surface. In such an embodiment, valve 192 may be selectively closed such that suction cup 146 is capable of providing a suction that couples it to the supporting surface. Thus, where a foot 124 of support 100 includes such a valve actuated suction cup 146, a user may readily move support 100 from one place to another without the movement being inhibited by suction cup 146. A user may selectively actuate valve 192 of suction cup 146 to facilitate coupling of suction cup 146 to the supporting surface when desirable. For example, each time support is moved, one or more of valve actuated suction cups 146 may simply rest on the supporting surface without being coupled to the supporting surface, and a user may selectively actuate valve 192 when it is desirable to inhibit movement via coupling of support 100 to the supporting surface.

FIGS. 5A and 5B illustrate a cross-sectioned view of valve 192 having an open biased configuration. Valve 192 includes plunger (e.g., valve stem) 204 coupled to a sealing member 207. In an open position, as depicted in FIG. 5A, sealing member 207 does not contact or seal against a flange 208 within an orifice 210 that extends between upper and lower ends of valve 192. In a closed position, as depicted in FIG. 5B, sealing member 207 contacts and seals against flange 208. In the illustrated embodiments, a bias member 212 (e.g., a compression spring) biases sealing member 207 away from flange 208 such that orifice 210 remains open when no restoring force is applied to plunger 204, as depicted in FIG. 5A. When a restoring force (see arrow in FIG. 5B) is applied to plunger 204 sealing member 207 contacts and seals against flange 208 to close orifice 210, thereby blocking the flow of air through orifice 210. In some embodiments, the restoring force may be provided via an upward pulling on plunger 204. For example, an actuation member 206, such as a cable coupled to plunger 204, may be pulled upward by a user to close valve 192.

In some embodiments, valve 192 is biased into a closed position such that suction cup 146 is capable of providing a suction that couples it to the supporting surface. In such an embodiment, valve 192 may be selectively opened to eliminate or reduce coupling of suction cup 146 to the supporting surface. Thus, where a foot 124 of support 100 includes such a valve actuated suction cup 146, support 100 may be capable of coupling with the supporting surface as it is moved into position (e.g., pressed against the supporting surface), and valve 192 of suction cup 146 may be selectively actuated to facilitate release of suction cup 146 from the supporting surface. For example, each time support is moved, valve actuated suction cup 146 may couple to the supporting surface to inhibit movement, and a user may selectively actuate valve 192 when it is desirable to move support 100.

FIGS. 5C and 5D illustrate a cross-sectioned view of valve 192 having a closed biased configuration. Valve 192 includes a plunger (e.g., valve stern) 204 that is coupled to a sealing member 207. In a closed position, as depicted in FIG. 5C, sealing member 207 contacts and seals against flange 208. In an open position, as depicted in FIG. 5D, sealing member 207 does not contact or seal against flange 208. In the illustrated embodiments, bias member 212 biases sealing member 207 into contact with flange 208 such that orifice 210 remains closed when no restoring force is applied to plunger 204, as depicted in FIG. 5C. When a restoring force is applied to plunger 204 (see arrow in FIG. 5D), sealing member 207 moves away from flange 208 to open orifice 210, thereby enabling the flow of air through orifice 210. In some embodiments, the restoring force may be provided via an upward pulling on plunger 204. For example, an actuation member 206, such as a cable coupled to plunger 204, may be pulled upward by a user (e.g., via movement of a lever) to close valve 192.

As described above, valve 192 may be actuated via actuation mechanism 206. In some embodiments, actuation mechanism 206 may be remotely operated by a user. For example, a portion of actuation mechanism 206 may include remotely located components that can be manipulated by a user to pull or release plunger 204. An actuator of actuation mechanism may be activated to induce a tension on a cable that couples the actuator to a plunger the valve, thereby pulling the plunger between the opened and closed positions. In some embodiments, at least a portion of cables are internally routed through one or more interior cavities of frame 110. In some embodiments, only a portion, some, substantially all, or all of the cable is routed internal within frame 110, and it is, thus, not exposed externally.

In some embodiments, support 100 may be formed of a metal frame. For example, one or more portions of support 100 may include metal tubing that is bent/welded to provide the desires shape and functionality. For example, support 100 of FIG. 2 may include multiple metal (e.g., aluminum) tubes that are bent into shape and subsequently coupled to one another to form support 100. In some embodiments, one or more portions of support 100 may be formed of a non-metallic material, such as a polymer and/or plastic composite or other composite material. For instance, portions of support 100 may be formed of acrylonitrile butadiene styrene (ABS). In some embodiments, support 100 may be formed from a carbon fiber reinforced material.

In some embodiments, one or more portions of support 100 may be molded. For example, front portion 101 and/or side portions 103 may include panels that are injection molded. Molding may enable support 100 to include a number of features that may not be easily achieved using traditional techniques used to form metal frame supports. For example, molding may enable forming ergonomic curvatures to facilitate portions of support being grasped by a user. Moreover, molding may provide seamless transitions from one support member to another, thereby reducing or eliminating sharp edge and corners. Molding may also enable integration of various internal features of support 100. For example, a portion of support 100 may be molded to include an integrated internal channel for routing cables that couples the actuator to a plunger of a valve and/or routing water to an integrated shower head.

In some embodiments, molding may include forming two or more panels that are subsequently coupled to one another to form a single-integral portion of support 100. For example, a right-panel half and a left-panel half used to form one of the front or side barrier portions may be formed separately via injection molding, and, then, may be boned or fastened to one another to form a single integrated panel. It will be appreciated that although the term half is used, these two portions may not be exact halves (e.g., may not be mirrored portions or have identical dimensions) but the terms is used for simplifying understanding of the two-panel configuration. Such a two-piece approach may enable forming panels that include a variety of internal features. For example, the resulting two-piece panel may include an internal cavities/channels, ribs/fins, or the like. An internal cavity may help to reduce the overall weight of support 100. An internal cavity/channel may provide for routing cables or similar elongated elements that couples the actuator to a plunger the valve. Ribs/fins may provide structural support that provides additional rigidity to the panel structure. The following discussion describes the two-panel technique with regard to a side panel portion of support 100, although such two-panel techniques may be applied to one, several or all of various portions of support, including front portion 101, and/or side portions 103a and 103b.

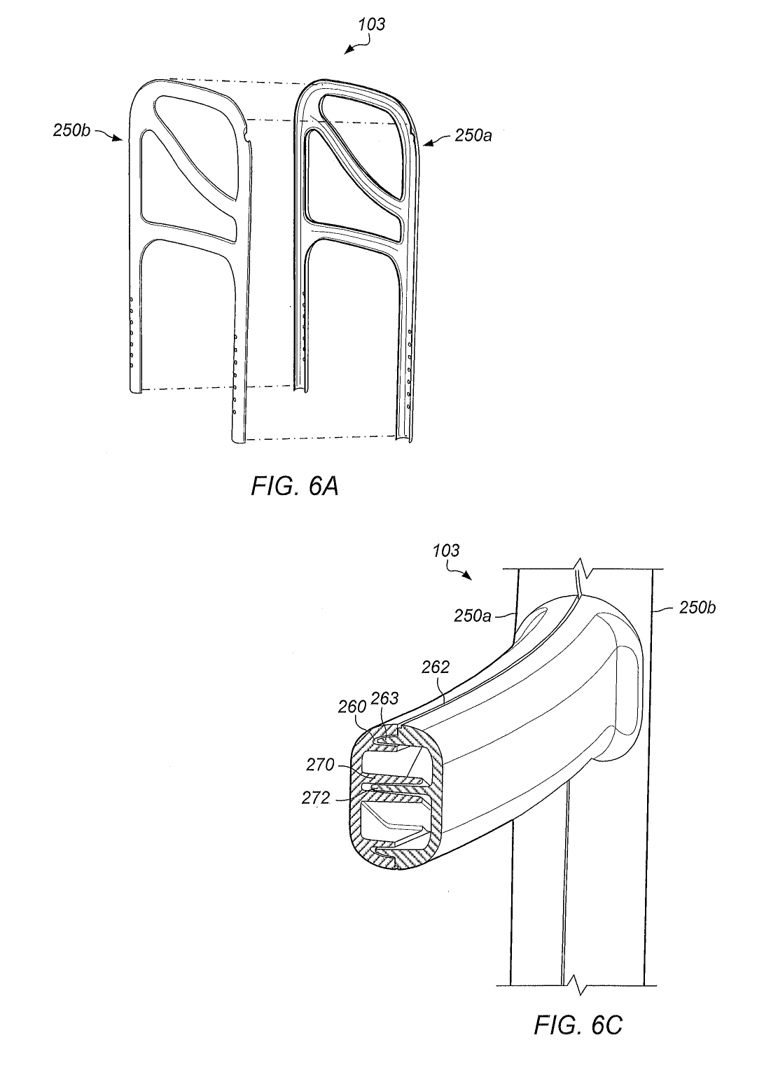

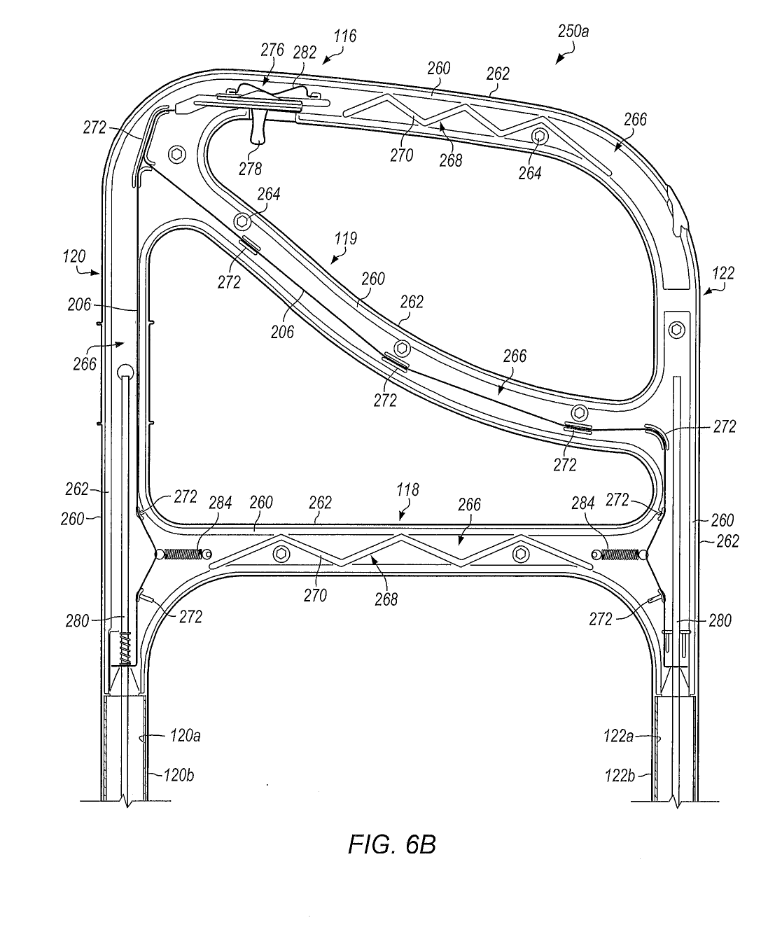

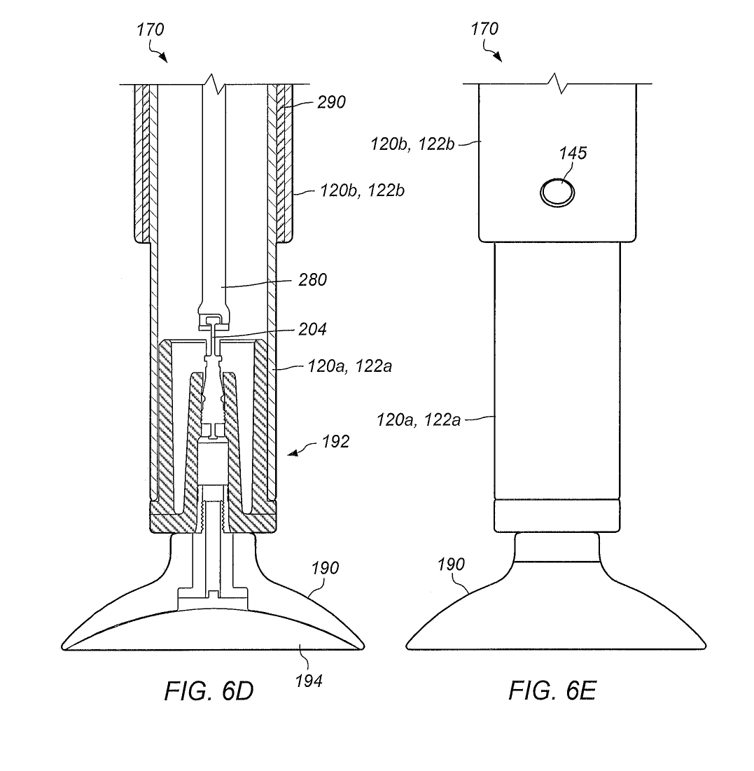

FIG. 6A illustrates an exploded perspective view of a side portion 103 in accordance with one or more embodiments of the present technique. More specifically, side portion 103 includes two panel portions 250a and 250b (e.g., two panel halves) that are coupled to one another to form side portion 103. In some embodiments, panel portions 250a and 250b include molded panel portions that are coupled to one another to form a single integrated side portion 103 of support 100. In some embodiments, panel portions 250a and 250b may be mechanically fastened to one another. For example, panel portion 250a and 250b may be fastened to one another via a mechanical fastener, such as a screw, rivet, clip, or the like. In some embodiments, panel portion 250a and 250b may be fastened to one another via an integrated mechanical interlock, such protrusion and recess that snap or clip to one another. In some embodiments, panel portions 250a and 250b may be bonded to one another. For example, panel portions 250a and 250b may be secured to one another using an adhesive and/or may be ultrasonically welded to one another. In some embodiments, panel portions 250a and 250b may be coupled to one another using only mechanical fastening or bonding, or may be coupled to one another via a combination of mechanical fastening, bonding techniques, or the like. As noted above, although the illustrated embodiment includes a side portion 103 of support 100, similar techniques may be employed to form other portions of support 100. For example, front portion 101, side portion 103a and/or side portion 103b may be formed and assembled via a similar technique.

FIG. 6B illustrates a more detailed sectioned view of a top portion of panel portion 250a, in accordance with one or more embodiments of the present technique. As illustrated, panel portion 250a may include numerous internal features that facilitate assembly and operation of support 100. In the illustrated embodiment, panel portion 250a includes recesses 260 that extend about external edges 262 of support 100. Recesses of edges 262 may accept a complementary protrusion of complementary panel portion 250b to facilitate coupling of panel portions 250a and 250b to one another. FIG. 6C illustrates a perspective-sectioned view of an exemplary interface between panel portions 250a and 250b. As depicted, a protrusion/lip 263 of panel portion 250b engages a complementary shaped recess 260 of panel portion 250a. In some embodiments, coupling of lip 262 and recess 260 may include use of an adhesive or other bonding agent and/or a mechanical fastener/interlock.

In the illustrated embodiment, panel portion 250a includes other recesses (e.g., bosses) 264 provided in various locations about the interior of panel portion 250a. Bosses 264 may accept a complementary protrusion (e.g., pin) of complementary panel portion 250b to facilitate coupling of panel portions 250a and 250b to one another. In some embodiments, coupling of bosses 264 and pins may include use of an adhesive or other bonding agent and/or a mechanical fastener/interlock.

In the illustrated embodiment, panel portions 250a include multiple depressions 266 that extend along the central portions of panel portion 250a that form members 116, 118, 119, 120 and 122 when panel portions 250a and 250b are assembled. Depressions 266 may include one or more curved troughs that form one or more hollow-interior cavities when panel portions 250a and 250b are assembled. In some embodiment, panel 250b may include one or more complementary depressions 266 that define the one or more hollow-interior cavities when panel portions 250a and 250b are assembled. The resulting interior cavities may help to reduce the overall weight of support 100 and may provide for routing cable that couples the actuator to valve.

In the illustrated embodiment, panel portion 250a includes structural supports 268 disposed in cavities 266. Structural supports 268 may include a series of ribs/fins that extend from depressions 266. Thus, structural supports 268 are provided internally when panel portions 250a and 250b are assembled. In some embodiments, structural supports 268 include recesses 270 that accept a complementary protrusion of complementary panel portion 250b to facilitate coupling of panel portions 250a and 250b to one another. FIG. 6C illustrates, a protrusion/lip 272 of panel portion 250b engaging a complementary shaped recess 270 of panel portion 250a. In some embodiments, coupling of lip 272 and recess 270 may include use of an adhesive or other bonding agent and/or a mechanical fastener/interlock. In some embodiments, structural supports 268 may be formed integral with panel portions 250a and/or 250b during the molding process. In the illustrated embodiment, structural supports 268 include a series of interconnected portions that are angled relative to one another to form an internal truss structure. The resulting truss structure may enhance rigidity of panel 103 when panel portions 250a and 250b are assembled. Other forms of internal structural support may be provided. For example, structural supports may be provided internal to the vertical members, intermediate member 119 and/or may include various shapes and arrangements.

In the illustrated embodiment, panel portion 250a includes guides 272 disposed in cavities 266. Guides 272 may include protrusions that extend from depressions 266 to define a path for routing of cable 206 that couples to the actuator to valve. In some embodiments, guides 272 include recesses that accept a complementary protrusion of complementary panel portion 250b to define the path.

In the illustrated embodiment, panel portion 250a includes an actuator mechanism 276 disposed in a recess 266 of panel portion 250a. Actuator mechanism 276 may be contained internal to side portion 103 when panel portions 250a and 250b are assembled. During operation, activation (e.g., depression or sliding)of button 278 of actuator mechanism 276 may overcome a bias force to generate a tension in cable 206, resulting in pulling-up on elongated members 280 to actuate plungers 204 as illustrated discussed in greater detail below with respect to FIG. 6D. In some embodiments, a leaf spring 282 biases the button 278 downward. In the illustrated embodiment, linear coil springs 284 are coupled to cable 206 to pull on the cables to take up slack in cable 206. In the illustrated embodiment, cable 206 is routed internally through vertical members 120 and 122 and intermediate member 119, although other embodiments may include routing cable 206 via any number of paths through support 100. For example, cable 206 may be routed through top member 116 as opposed to intermediate member 119. As depicted, cable 206 may be routed internally such that none of cable 206 is exposed. Minimizing exposure of cable 206 may protect it from wear and may prevent accidental actuation of valve 192 that may otherwise occur if an exposed portion of cable 206 was snagged or bumped during use.

Although the illustrated embodiment includes a slide style actuator mechanism 276, actuator mechanism may take various forms. For example, actuator 276 may include a brake style handle that can be depressed to create a tension in cable 206, thereby actuating valve 192 of foot 146. In some embodiments, actuator 276 may include a member that is rotated left or right to pull, push or otherwise move cable 276.

FIG. 6D illustrates a cross-sectioned view of lower portions 170 of support 100 (e.g., the lower ends of vertical members) of FIG. 6B in accordance with one or more embodiments of the present technique. In the illustrated embodiment, upper portion 120b, 122b of vertical support member 120, 122 includes a sleeve 290 disposed therein. Sleeve 290 may include a rigid, wear resistant material, such as a metal sleeve, that provide increased rigidity and support for the vertical member of support 100. In some embodiments, sleeve 290 may include a plurality of holes to accept biased pins of locking mechanism 142. In some embodiments, sleeve 290 may distribute the shear force of the biased pin such that a significant amount of force is not exerted on the complementary holes in the exterior of panel portions 250a or 250b. Thus, the vertical member of support 100 may be capable of supporting an increased amount of weight as a user presses down on support 100. In some embodiments, sleeve 290 may be slid into an interior cavity of vertical members 120, 122 prior to, during or after assembly of panel portions 250a and 250b. For example, sleeve 290 may slid into an exposed cavity at the bottom of members 120 and 122 after portions 250a and 250b are assembled.

In some embodiments, actuation mechanism 276 may includes a lever that can be manipulated by a user to move cable 206. For example, actuation mechanism 276 may include a brake style handle that can be depressed to create a tension in cable 206, thereby actuating valve 192 of foot 146. In some embodiments, actuation mechanism 276 may be rotated left or right to pull, push or otherwise move cable 206. In some embodiments, actuation mechanism 276 may be biased. For example, actuation mechanism 276 may be biased into a position such that no effective tension is provided on cable 206 unless actuation mechanism 276 is manipulated by a user. In some embodiments, actuation mechanism 276 may be biased to enable a foot to be biased to a certain state. In such an embodiment, a user may depress/move actuation mechanism 276 to overcome the bias and to create tension in cable 206 to actuate valve 192.

In the illustrated embodiment of FIG. 1A, each of vertical members 120/122 are depicted as including valve actuated suction cups 146. In some embodiments, support 100 may include any number of valve actuated suction cups 146. For example, some of feet 124 may include valve actuated suction cups 146. For example, valve actuated suction sups may be located only on the rear vertical member 122 and may not be located at the front vertical members 120. In some embodiments, front vertical 120 members may include feet 124 that facilitate movement of support 100 (e.g., sliding pads or wheels).

In the illustrated embodiment of FIG. 6B, multiple cables may be coupled to a single actuator. In some embodiments, each of the cables may be coupled to a single actuation mechanism 276. Movement of actuation mechanism 276 may simultaneously induce tension into multiple cables 206, thereby actuating multiple valves. Accordingly, where each of the four feet 124 illustrated includes a valve actuated suction cup, four connectors may be routed to a single actuator to simultaneously induce tension into all four cables 206 to actuate the feet. In some embodiments, actuation may actuate suction cups and other types of feet (e.g., wheels) between various states. For example, actuation of one or more actuation mechanisms 276 may simultaneously actuate valve actuated suction cups and rollers to an unlocked state.

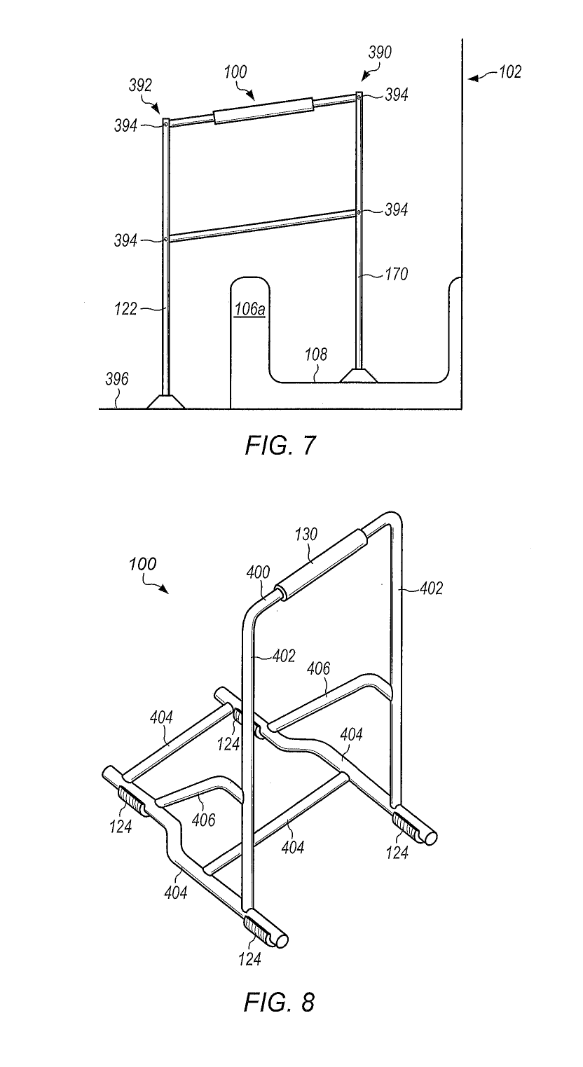

FIG. 7 illustrates positioning of support 100 during use, in accordance with one or more embodiments of the present technique. In the illustrated embodiment, a portion of support 100 is positioned internal to shower/bathtub 102 and a portion of support 100 is positioned outside of shower/bathtub 102. More specifically, support 100 straddles a lower wall portion 106a of shower/bathtub106 such that a front portion 390 of support 100, including front vertical members 120, is positioned in shower/bathtub 102, and a rear portion 392 of support 100, including rear vertical members 122, is positioned outside of shower/bathtub 102 (e.g., on a bathroom floor 396). During use a person may use support 100 to assists them during entry and exit of shower/bathtub 102 and/or during bathing in shower/bathtub 102. This may further enable support 100 to be used in smaller (e.g., narrower) showers/bathtubs where the overall dimensions of support 100 may be too large to fit in the shower/bathtub. As depicted, support 100 may include additional pivot points 394, such as those at the union of cross and vertical members to enable support 100 to automatically adjust (e.g., rotate) to accommodate varying heights of flooring, such as the difference in height between bathroom floor 396 and bottom surface 108 of shower/bathtub 102.

Other embodiments of support 100 may include alternate arrangements of members to provide structural integrity to support a person during use. FIG. 8 illustrates an alternate embodiment of support 100 that includes a plurality of members coupled to one another to form support 100. In the illustrated embodiment, a single upper cross-member 400 is supported by two vertical cross-members 402 that are coupled to lower members 404 that define a generally rectangular shaped frame, and is further supported by diagonal members 406 that extend in at an approximately forty-five degree angle between a mid portion of vertical member 402 and lower members 404. Support 100 includes a pad/grip 130 on upper cross-member 400 and four feet 124 (e.g., suction cups 126, pads 128 and/or roller 129) located on lower members 404. Upper cross-member 400 is positioned at a height suitable for use and support of a person while standing in a shower/bathtub. For example, cross-member 400 may be positioned at a height of about thirty-six inches, or a similar dimension typically associated with a height for grasping by a user while showering (e.g., about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60 or more inches). Although not depicted, other features described herein may be employed in certain embodiments. For example, support 100 may include adjustable members, a foot rest, an accessory container, or the like.

As noted above, support 100 may be formed from a variety of materials suitable for use in bathing environments. For example, frame 110 and other portions of support 100 may be formed from metals, plastics, composites, or the like. In some embodiments, support 100 may be formed from an anti-corrosive material and/or include an anti-corrosive material. Anti-corrosive materials may be resistant to corrosion in a damp or wet environment, such as the bathing environment. In some embodiments, portions or substantially all of support 100 may be formed from plastic materials, such as polyvinyl chloride (PVC). In some embodiments, a combination of materials may be used. For example support 100 may include a metal or composite frame and plastic or PVC conduit used to route an integral water source.

Further modifications and alternative embodiments of various aspects of the invention will be apparent to those skilled in the art in view of this description. For example, any of the embodied features described herein with respect to one figure may be combined with features described herein with respect to any one of the other figures. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. The words “include”, “including”, and “includes” mean including, but not limited to. As used herein, the singular forms “a”, “an” and “the” include plural referents unless the content clearly indicates otherwise. Thus, for example, reference to “a member” may include a combination of two or more members.

What is claimed is:

1. A portable personal support, comprising:
a frame comprising a support member of sufficient height to be grasped by a human while in a standing position, wherein the frame comprises a three-sided barrier comprising:
at least one front barrier portion configured to be disposed in front of user during use; and
at least two side barrier portions configured to be disposed on either side of the user during use;
wherein at least one of the barrier portions comprises a first panel portion and a second panel portion complementary to the first panel portion coupled to one another to form an integral barrier portion, wherein at least a portion of the first panel portion comprises a first edge portion and at least a portion of the second panel comprises a second edge portion complementary to the first edge portion that engage one another, and wherein at least a portion of the first panel and a complementary portion of the second panel define at least a portion of a hollow interior cavity of the integral barrier portion.

2. The portable personal support of claim 1, wherein the first panel portion and the second panel portion are at least partially bonded to one another to form the integral barrier portion.

3. The portable personal support of claim 2, wherein the first edge portion and the second edge portion are at least partially bonded to one another to form a seam between the first panel portion and the second panel portion.

4. The portable personal support of claim 1, wherein the first panel portion and the second panel portion are at least partially mechanically coupled to one another to form the integral barrier portion.

5. The portable personal support of claim 4, wherein the first panel portion and the second panel portion are at least partially coupled to one another via a mechanical fastener.

6. The portable personal support of claim 4, wherein the first panel portion and the second panel portion are at least partially coupled to one another via a mechanical interlock.

7. The portable support of claim 1, wherein at least one of the first edge portion and the second edge portion comprise a recess and the other of the first edge portion and the second edge portion comprises a protrusion complementary to the recess, wherein the protrusion engages the recess when the first panel portion and the second panel portion are coupled to one another to form the integral barrier portion.

8. The portable support of claim 1, wherein the hollow interior cavity comprises a structural support member disposed therein.

9. The portable support of claim 8, wherein the structural support member comprises one or more integral ribs and/or fins coupled to an interior surface of the first panel portion and/or the second panel portion.

10. The portable support of claim 9, wherein a complementary portion of the other of the first panel portion or the second panel portion comprises one or more recesses complementary to the one or more ribs and/or fins, wherein the one or more ribs and/or fins engages at least a portion of the one or more recesses when the first panel portion and the second panel portion are coupled to one another to form the integral barrier portion.

11. The portable support of claim 1, wherein at least a portion of the hollow interior cavity defines a channel for passing a cable there through.

12. The portable support of claim 1, wherein at least one of the first panel portion and the second panel portion are molded from a composite material.

13. A method for assembling a personal support, comprising:
providing first panel portion of a barrier portion of the personal support, wherein the first panel portion comprises a first edge portion, wherein the first panel portion comprises a portion of at least one barrier portion of the personal support, wherein the personal support comprises a frame comprising a support member of sufficient height to be grasped by a human while in a standing position, and wherein the frame comprises a three-sided barrier comprising:
at least one front barrier portion configured to be disposed in front of user during use; and
at least two side barrier portions configured to be disposed on either side of the user during use;
providing a second panel portion of the barrier portion of the personal support, wherein the second panel portion is complementary to the first panel portion, and wherein the second panel portion comprises a second edge portion complementary to the first edge portion; and
coupling the first panel portion and the second panel portion to one another to form an integral barrier portion, wherein coupling the first panel portion and the second panel portion to one another comprises engaging the first edge portion and the second edge portion to one another, wherein at least a portion of the first panel and a complementary portion of the second panel define at least a portion of a hollow interior cavity of the integral barrier portion.

14. The method of claim 13, wherein coupling the first panel portion and the second panel portion to one another comprises bonding at least a portion of the first panel portion and the second panel portion to one another.

15. The method of claim 14, wherein coupling comprises at least partially bonding the first edge portion and the second edge portion to one another to form a seam between the first panel portion and the second panel portion.

16. The method of claim 13, wherein coupling comprises at least partially mechanically coupling the first edge portion and the second edge portion to one another.

17. The method of claim 16, wherein coupling comprises at least partially mechanically coupling the first edge portion and the second edge portion to one another using a mechanical fastener.

18. The method of claim 16, wherein coupling comprises at least partially mechanically coupling the first edge portion and the second edge portion to one another via a mechanical interlock.

19. The method of claim 13, wherein at least one of the first edge portion and the second edge portion comprise a recess and the other of the first edge portion and the second edge portion comprises a protrusion complementary to the recess, wherein coupling comprises engaging the protrusion with the recess.

20. The method of claim 13, wherein the hollow interior cavity comprises a structural support member disposed therein.

21. The method of claim 20, wherein the structural support member comprises one or more integral ribs and/or fins coupled to an interior surface of the first panel portion and/or the second panel portion.

22. The method of claim 21, wherein a complementary portion of the other of the first panel portion of the second panel portion comprises one or more recesses complementary to the one or more ribs and/or fins, wherein coupling comprises engaging the one or more ribs and/or fins with at least a portion of the one or more recess.

23. The portable support of claim 13, wherein at least a portion of the hollow interior cavity defines a channel for passing a cable there through.

24. The portable support of claim 23, comprising disposing a wire/cord/string in the channel prior to coupling the first panel portion and the second panel portion.

25. The portable support of claim 13, wherein at least one of the first panel portion and the second panel portion are molded from a composite material.

26. A portable support comprising:
a frame comprising a support member of sufficient height to be grasped by a human while in a standing position, wherein the frame comprises a three-sided barrier comprising:
at least one front barrier portion configured to be disposed in front of user during use; and
at least two side barrier portions configured to be disposed on either side of the user during use,
wherein at least one of the barrier portions comprises a first panel portion configured to be mated to a second panel portion complementary to the first panel portion to form an integral barrier portion, wherein at least a portion of the first panel portion comprises a recess/protrusion configured to engage a complementary protrusion/recess of the second panel portion when the first portion is mated to the second panel portion, wherein at least a portion of the first panel comprises a depression configured to define at least a portion of a hollow interior cavity of the integral barrier portion when the first portion is mated to the second panel portion, and wherein the hollow interior cavity comprises a structural support member disposed therein.

27. A portable personal support, comprising:
a frame comprising a support member of sufficient height to be grasped by a human while in a standing position; and
at least one foot coupled to the frame and configured to contact a supporting surface during use, wherein at least one foot comprises a valve actuated suction cup comprising:
a sealing cup configured to directly contact the supporting surface during use, wherein the sealing cup comprises a concave recess having an interior volume;
an orifice extending between the interior volume and an exterior volume; and
a valve coupled to the orifice, wherein the valve is configured to be actuated between an open and a closed position to regulate the flow of air into and out of the interior volume via the orifice,
wherein providing the valve in the closed position is configured to facilitate coupling of the valve actuated suction cup to the supporting surface during use, and wherein providing the valve in the opened position is configured to inhibit coupling of the valve actuated suction cup to the supporting surface during use.

28. The portable personal support of claim 27, wherein the valve is biased to the closed position.

29. The portable personal support of claim 27, wherein the valve is biased to the opened position.

30. The portable personal support of claim 27, wherein the valve comprises a plunger, and wherein linear actuation of the plunger is configured to operate the valve between the opened and closed positions.

31. The portable personal support of claim 27, further comprising a remote actuator used to actuate the valve, wherein the remote actuator is disposed within reach of a user such that the user may actuate the valve while in the standing position.

32. The portable personal support of claim 27, further comprising an elongated member configured to actuate the valve routed internal to one or more members of the frame.

33. The portable personal support of claim 27, wherein the portable personal support comprises a walker.

34. The portable personal support of claim 27, wherein the portable personal support comprises a bathing support configured to fit within a shower and/or bathtub used for bathing, and wherein the portable bathing support is configured for use by a human in a standing position without being fixedly coupled to the shower and/or bathtub.

35. A portable bathing support, comprising:
a frame comprising a support member of sufficient height to be grasped by a human while in a standing position; and
at least three feet coupled to the frame, wherein at least one of the feet comprises a valve actuated suction cup configured to selectively at least partially couple the portable bathing support to a shower and/or bathtub supporting surface during use,
wherein the valve actuated suction cup comprises:
a sealing cup configured to directly contact the supporting surface during use, wherein the sealing cup comprises:
a concave recess having an interior volume; and
an orifice extending between the interior volume and an exterior volume; and
a valve coupled to the orifice, wherein the valve is configured to be actuated between an opened and a closed position to regulate the flow of air into and out of the interior volume via the orifice,
wherein providing the valve in the closed position is configured to facilitate coupling of the valve actuated suction cup to the supporting surface during use, wherein providing the valve in the opened position is configured to inhibit coupling of the valve actuated suction cup to the supporting surface during use, and
wherein the portable bathing support is configured to fit within a shower and/or bathtub used for bathing, and wherein the portable bathing support is configured for use by a human in a standing position without being fixedly coupled to the shower and/or bathtub.

36. The portable bathing support of claim 35, wherein the valve is biased to the closed position.

37. The portable bathing support of claim 35, wherein the valve is biased to the opened position.

38. The portable bathing support of claim 35, wherein the valve comprises a plunger, and wherein linear actuation of the plunger is configured to operate the valve between the opened and closed positions.

39. The portable bathing support of claim 35, further comprising a remote actuator used to actuate the valve, wherein the remote actuator is disposed within reach of a user such that the user may actuate the valve while in the standing position.

40. The portable bathing support of claim 35, wherein the frame comprises a three-sided barrier comprising a front portion configured to be disposed between a user and a water supply during use, and a rear portion opposite the front portion, wherein the rear portion comprises an opening accessible by the user to allow the user to walk to a position where the three sides can be grasped by the user while in a standing position.

41. The portable bathing support of claim 35, wherein the frame comprises an adjustable width.

42. The portable bathing support of claim 359, where each of the feet configured to contact the supporting surface during use comprise a valve actuated suction cup.

43. The portable bathing support of claim 35, further comprising an elongated member configured to actuate the valve, wherein at least a portion of the elongated member is routed internal to one or more members of the frame.

44. A walker support for a human, comprising:
a frame comprising a support member of sufficient height to be grasped by a human while in a standing position; and
at least three feet coupled to the frame, wherein at least one of the feet comprises a valve actuated suction cup configured to selectively at least partially couple the walker to a supporting surface during use,
wherein the valve actuated suction cup comprises:
a sealing cup configured to directly contact the supporting surface during use, wherein the sealing cup comprises:
a concave recess having an interior volume; and
an orifice extending between the interior volume and an exterior volume; and
a valve coupled to the orifice, wherein the valve is configured to be actuated between an opened and a closed position to regulate the flow of air into and out of the interior volume via the orifice,
wherein providing the valve in the closed position is configured to facilitate coupling of the valve actuated suction cup to the supporting surface during use, and wherein providing the valve in the opened position is configured to inhibit coupling of the valve actuated suction cup to the supporting surface during use.

45. The walker support of claim 44, wherein the valve is biased to the closed position.

46. The walker support of claim 44, wherein the valve is biased to the opened position.

47. The walker support of claim 44, wherein the valve comprises a plunger, and wherein linear actuation of the plunger is configured to operate the valve between the opened and closed positions.

48. The walker support of claim 44, further comprising a remote actuator used to actuate the valve, wherein the remote actuator is disposed within reach of a user such that the user may actuate the valve while in the standing position.

49. The walker support of claim 44, further comprising:
a pair of front vertical support members and a pair of rear vertical support members,
a foot comprising a valve actuated suction cup coupled to each of the rear vertical support members, and
a foot configured to facilitate movement of the walker coupled to each of the front vertical support members.

50. The walker support of claim 44, where each foot of the walker support that is configured to contact the supporting surface during use comprises a valve actuated suction cup.

51. The walker support of claim 44, further comprising an elongated member configured to actuate the valve, wherein at least a portion of the elongated member is routed internal to one or more members of the frame.

52. A portable personal support system, comprising:
a frame comprising a support member of sufficient height to be grasped by a human while in a standing position; and
at least three feet coupled to the frame, wherein at least one of the feet comprises a suction cup configured to at least partially couple the frame to a supporting surface during use, wherein the suction cup comprises a flexible sealing cup configured to directly contact the supporting surface during use, and wherein the sealing cup is configured to generate a suction to at least partially couple the frame to the supporting surface.

53. The portable support system of claim 52, wherein the sealing cup comprises a concave recess having an interior volume configured to be provided adjacent the supporting surface during use.

54. The portable support system of claim 52, wherein the suction cup comprises a valve actuated suction cup.

55. The portable support system of claim 52, further comprising:
two or more front vertical support members and two or more rear vertical support members,
a foot comprising a valve actuated suction cup coupled to each of the rear vertical support members, and
a foot configured to facilitate movement of the walker coupled to each of the front vertical support members.

56. The portable support system of claim 52, where each of the feet comprises a suction cup.

57. The portable support system of claim 56, wherein each of the suction cups comprise a valve actuated suction cup.

58. A portable bathing support for use in a standing position, comprising:
a frame comprising a support member of sufficient height to be grasped by a human while in a standing position; and
at least three feet coupled to the frame, wherein the feet are configured to provide a friction between the frame and a supporting surface, and wherein at least one foot comprises a suction cup configured to at least partially couple the portable bathing support to a shower and/or bathtub supporting surface during use,
wherein the portable bathing support is configured to fit within a shower and/or bathtub used for bathing, and wherein the portable bathing support is configured for use by a human in a standing position without being fixedly coupled to the shower and/or bathtub.

59. The portable bathing support of claim 58, wherein the frame comprises a three-sided barrier comprising a front portion configured to be disposed between a user and a water supply during use, and a rear portion opposite the front portion and comprising an opening accessible by a human to allow the human to walk to a position where three sides can be grasped by the human while in a standing position.

60. The portable bathing support of claim 58, wherein one or more sides of the frame is foldable.

61. The portable bathing support of claim 60, wherein the frame is configured to be substantially flat when folded.

62. The portable bathing support of claim 58, wherein the portable bathing support is configured to be substantially immovable due to a friction force between a portion of the portable bathing support and the shower and/or bathtub supporting surface.

63. The portable bathing support of claim 58, wherein the at least three feet comprise two or more suction cups disposed on a lower portion of the portable bathing support.

64. The portable bathing support of claim 58, wherein the at least three feet comprise at least one pad.

65. The portable bathing support of claim 58, wherein the at least three feet comprise at least one suction cup and at least one pad disposed substantially adjacent to one another on a substantially horizontal member of a lower portion of the portable bathing support.

66. The portable bathing support of claim 58, wherein at least one of the at least three feet comprise a surface configured to repel and/or channel water away from a contact surface.

67. The portable bathing support of claim 58, wherein the frame comprises an adjustable height.

68. The portable bathing support of claim 67, wherein the frame comprises a substantially vertical member having an adjustable length.

69. The portable bathing support of claim 58, wherein the frame comprises an adjustable width.

70. The portable bathing support of claim 69, wherein the frame comprises a substantially horizontal member having an adjustable length.

71. The portable bathing support of claim 58, comprising a water supply support configured to support a water supply device.

72. The portable bathing support of claim 58, comprising an integral water conduit.

73. The portable bathing support of claim 72, wherein the integral water conduit comprises an inlet couplable to a water supply, a hollow conduit integral with the frame, and an outlet couplable to a water supply device and located proximate an upper portion of the frame.

74. The portable bathing support of claim 58, comprising one or more extendable members proximate a lower portion of the support that are configured to translate between at least a first and second position to vary the effective width of a lower portion of the support.

75. The portable bathing support of claim 74, wherein the one or more extendable members comprise a member rotatable between at least an extended position and a retracted position.

76. The portable bathing support of claim 74, wherein the one or more extendable members comprises a member laterally translatable between an extended position and a retracted position, and comprising a biasing member configured to bias the member toward the extended position.

77. A method of bathing while standing, comprising:
disposing a portable bathing standing support at least partially into a shower and/or bathtub used for bathing, wherein the portable bathing support comprises:
a frame, comprising:
a support member of sufficient height to be grasped by a human while in a standing position; and
a three-sided barrier, wherein the three-sided barrier comprises a front portion configured to be disposed between a user and a water supply during use, and a rear portion opposite the front portion and comprising an opening accessible by a human to allow the human to walk to a position where three sides can be grasped by the human while in a standing position; and
at least three feet coupled to the frame, wherein the feet are configured to provide a friction between the frame and a supporting surface, and wherein at least one foot comprises a suction cup configured to at least partially couple the portable bathing support to a shower and/or bathtub supporting surface during use,
wherein the portable bathing support is configured to fit within a shower and/or bathtub used for bathing, and wherein the portable bathing support is configured for use by a human in a standing position without being fixedly coupled to the shower and/or bathtub during use.

78. A portable bathing support, comprising:
a frame comprising:
at least two substantially vertical front support members;
at least one substantially horizontal front support member of sufficient height to be grasped by a user while in a standing position, wherein at least one substantially horizontal front support member extends between the two substantially vertical front support members;
at least two substantially vertical rear support members; and
at least two side support members of sufficient height to be grasped by a user while in a standing position, wherein each of the at least two side support members extends between one of the two substantially vertical front support members and one of the two substantially vertical rear support members,
wherein the frame forms a three-sided barrier comprising a front portion configured to be disposed between a user and a water supply during use, and a rear portion opposite the front portion and comprising an opening accessible by a human to allow the human to walk to a position where three sides can be grasped by the human while in a standing position;
wherein the at least two substantially vertical front support members and the at least two substantially vertical rear support members are adjustable in length such that a height of the bathing support is adjustable;
wherein the at least one substantially horizontal front support member is adjustable in length such that a width of the bathing support is adjustable; and
one or more feet coupled to a lower portion of the frame, wherein the one or more feet are configured to at least partially couple the portable bathing support to a porcelain shower and/or bathtub supporting surface during use.

79. The portable bathing support of claim 78, wherein the frame further comprises at least one substantially horizontal support member at a lower portion of the portable bathing support, wherein the at least one substantially horizontal support member comprises at least one suction cup and at least one pad disposed substantially adjacent to one another and configured to at least partially couple to a porcelain shower and/or bathtub supporting surface during use.

80. The portable bathing support of claim 78, further comprising:
a container removable attached to the frame, wherein the container is configured to hold one or more bathing supplies;
a water supply support coupled to the frame, wherein the water supply support is configured to retain a water supply device; and
a foot support coupled to the frame, wherein the foot support comprises a platform configured to be positioned above the surface supporting the portable bathing support during use.

81. A portable support for use in a standing position, comprising:
a frame comprising a support member of sufficient height to be grasped by a human while in a standing position;
at least one securing foot coupled to the frame, wherein one or more of the at least one securing foot is configured to provide a friction between the frame and a supporting surface, and wherein one or more of the at least one securing foot comprises a suction cup configured to at least partially couple the portable support to a supporting surface during use; and
at least one roller foot coupled to the frame, wherein one or more of the at least one roller foot is configured to facilitate movement between the portable bathing support and the supporting surface during use.

82. The portable support of claim 81, wherein the portable support comprises a bathing support configured to fit within a shower and/or bathtub used for bathing, and wherein the portable bathing support is configured for use by a human in a standing position without being fixedly coupled to the shower and/or bathtub.

83. The portable support of claim 82, wherein the frame comprises a three-sided barrier comprising a front portion configured to be disposed between a user and a water supply during use, and a rear portion opposite the front portion and comprising an opening accessible by a human to allow the human to walk to a position where three sides can be grasped by the human while in a standing position.

84. The portable support of claim 81, wherein one or more sides of the frame is foldable.

85. The portable support of claim 84, wherein the frame is configured to be substantially flat when folded.

86. The portable support of claim 81, wherein the portable support is configured to be substantially immovable due to a friction force between the securing foot and the supporting surface.

87. The portable support of claim 81, wherein the at least one securing foot comprises two or more suction cups disposed on a lower portion of the bathing support.

88. The portable support of claim 81, wherein the at least one securing foot comprises at least one non-slip pad.

89. The portable support of claim 81, wherein the at least one securing foot comprises at least one suction cup and at least one non-slip pad disposed substantially adjacent to one another on a substantially horizontal member of a lower portion of the portable support.

90. The portable support of claim 81, wherein one or more of the at least one securing foot is disposed substantially adjacent to one or more of the at least one roller.

91. The portable support of claim 81, wherein one or more of the at least one securing foot comprises a dynamic suction cup disposed adjacent one or more of the at least one roller foot, wherein the dynamic suction cup is configured to be moveable between an engaged and a disengaged position, wherein the engaged position comprises the section cup coupled to the supporting surface such that it inhibits movement of the portable bathing support, and wherein the disengaged position comprises the suction uncoupled from the supporting surface such that it facilitates movement of the portable bathing support on one or more of the at least one roller foot during use.

92. The portable support of claim 81, wherein one or more of the at least one roller foot comprises a caster wheel.

93. The portable support of claim 81, wherein one or more of the at least one roller foot comprises a lockable wheel configured to inhibit rolling when locked.

94. The portable support of claim 81, wherein one or more of the at least one securing foot comprises a dynamic suction cup and one or more of the at least one roller foot comprises a lockable roller, wherein the lockable roller is configured to be automatically locked/unlocked in unison with engagement/disengagement of the dynamic suction cup.

95. The portable support of claim 81, wherein the frame comprises an adjustable height.

96. The portable support of claim 95, wherein the frame comprises a substantially vertical member having an adjustable length.

97. The portable support of claim 81, wherein the frame comprises an adjustable width.

98. The portable support of claim 97, wherein the frame comprises a substantially horizontal member having an adjustable length.

99. A method of bathing while standing, comprising:
disposing a portable bathing standing support at least partially into a shower and/or bathtub used for bathing, wherein the portable bathing support comprises:
a frame, comprising:
a support member of sufficient height to be grasped by a human while in a standing position; and
a three-sided barrier, wherein the three-sided barrier comprises a front portion configured to be disposed between a user and a water supply during use, and a rear portion opposite the front portion and comprising an opening accessible by a human to allow the human to walk to a position where three sides can be grasped by the human while in a standing position;
at least one securing foot coupled to the frame, wherein one or more of the at least one securing foot are configured to provide a friction between the frame and a supporting surface, and wherein one or more of the at least one securing foot comprises a suction cup configured to at least partially couple the portable bathing support to a shower and/or bathtub supporting surface during use; and
at least one roller foot coupled to the frame, wherein one or more of the at least one roller foot is configured to facilitate movement between the portable bathing support and the supporting surface during use,
wherein the portable bathing support is configured to fit within a shower and/or bathtub used for bathing, and wherein the portable bathing support is configured for use by a human in a standing position without being fixedly coupled to the shower and/or bathtub during use.

100. A portable support, comprising:
a frame comprising:
at least two substantially vertical front support members;
at least one substantially horizontal front support member of sufficient height to be grasped by a user while in a standing position, wherein at least one substantially horizontal front support member extends between the two substantially vertical front support members;
at least two substantially vertical rear support members; and
at least two side support members of sufficient height to be grasped by a user while in a standing position, wherein each of the at least two side support members extends between one of the two substantially vertical front support members and one of the two substantially vertical rear support members,
wherein the frame forms a three-sided barrier comprising a front portion, and a rear portion opposite the front portion and comprising an opening accessible by a human to allow the human to walk to a position where three sides can be grasped by the human while in a standing position;
wherein the at least two substantially vertical front support members and the at least two substantially vertical rear support members are adjustable in length such that a height of the support is adjustable;
wherein the at least one substantially horizontal front support member is adjustable in length such that a width of the support is adjustable; and
at least two feet coupled to a lower portion of the frame, wherein one or more of the at least two feet are configured to at least partially couple the portable support to a supporting surface, and one or more of the at least two feet are configured to facilitate movement of the portable support during use.

101. The portable support of claim 100, wherein one or more of the at least two feet comprises at least one dynamic suction cup disposed adjacent at least one roller, wherein one or more of the at least one dynamic suction cup is configured to be moveable between an engaged and a disengaged position, wherein the engaged position comprises a suction cup coupled to a supporting surface such that it inhibits movement of the portable bathing support, and wherein the disengaged position comprises the suction cup uncoupled from the support surface such that it facilitates movement of the portable support on one or more of the at least one roller during use
